(19) United States
(12) Patent Application Publication
(10) Pub. No.: US 2006/0091005 A1
(43) Pub. Date: May 4, 2006

(54) Electolytic processing apparatus

(76) Inventors: Yasushi Toma, Tokyo (JP); Itsuki Kobata, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/528,584

(22) PCT Filed: Oct. 2, 2003
(86) PCT No.: PCT/JP03/12651

§ 371 Date: Mar. 21, 2005

(30) Foreign Application Priority Data
Oct. 8, 2002 (JP) 2002-295435

(51) Int. Cl. B23H 3/04; C25B 11/00

(52) U.S. Cl. 204/290.11; 204/290.01

(57) ABSTRACT

An electrolytic processing apparatus has at least one processing electrode (86) and at least feeding electrode (86) disposed on the same side as the processing electrode (86) with respect to a substrate (W). An organic compound having an ion exchange group is chemically bonded to at least one of a surface of the processing electrode (86) and a surface of the feeding electrode (86b) to form an ion exchanger (90). The electrolytic processing apparatus also has a substrate holder (42) for holding the substrate (W) and bringing the substrate (W) into contact with or close to the processing electrode (86). The electrolytic processing apparatus includes a power supply (48) for applying a voltage between the processing electrode (86) and the feeding electrode (86), and a fluid supply unit (92, 94) for supplying a fluid between the substrate (W) and the processing electrode (86).

### TECHNICAL FIELD

The present invention relates to an electrolytic processing apparatus, and more particularly to an electrolytic processing apparatus useful for processing a conductive material formed on a surface of a substrate such as a semiconductor wafer or for removing impurities attached to a surface of a substrate. The present invention also relates to a substrate processing apparatus having such an electrolytic processing apparatus.

### BACKGROUND ART

In recent years, there has been a growing tendency to replace aluminum or aluminum alloy as a metallic material for forming interconnection circuits on a substrate such as a semiconductor wafer with copper (Cu) having a low electric resistivity and a high electromigration resistance. Copper interconnections are generally formed by filling copper into fine recesses formed in a surface of a substrate. As methods for forming copper interconnections, there have been employed chemical vapor deposition (CVD), sputtering, and plating. In any of the methods, after a copper film is formed on substantially the entire surface of a substrate, unnecessary copper is removed by chemical mechanical polishing (CMP).

FIGS. 1A through 1C show an example of a process of forming a copper interconnection in a substrate W. As shown in FIG. 1A, an insulating film 2, such as an oxide film of SiO₂ or a film of low-k material, is deposited on a conductive layer 1a on a semiconductor base 1 on which semiconductor devices have been formed. A contact hole 3 and an interconnection groove 4 are formed in the insulating film 2 by lithography etching technology. Then, a barrier layer 5 made of TaN or the like is formed on the insulating film 2, and a seed layer 7, which is used as a feeding layer for electrolytic plating, is formed on the barrier layer 5 by sputtering, CVD, or the like.

Subsequently, as shown in FIG. 1B, a surface of the substrate W is plated with copper to fill the contact hole 3 and the interconnection groove 4 with copper and to form a copper film 6 on the insulating film 2. Thereafter, the surface of the substrate W is polished by chemical mechanical polishing (CMP) to remove the copper film 6 on the insulating film 2 so that the surface of the copper film 6 filled in the contact hole 3 and the interconnection groove 4 is made substantially even with the surface of the insulating film 2. Thus, as shown in FIG. 1C, an interconnection comprising the copper film 6 is formed in the insulating layer 2.

Recently, components in various types of equipment have become finer and have required higher accuracy. As submicronic manufacturing technology has commonly been used, the properties of the materials are greatly influenced by the machining method. Under these circumstances, in a conventional mechanical machining method in which a desired portion in a workpiece is physically destroyed and removed from a surface thereof by a tool, a large number of defects may be produced by the machining, thus deteriorating the properties of the workpiece. Therefore, it is important to perform machining without deteriorating the properties of materials.

Some processing methods, such as chemical polishing, electrochemical machining, and electrolytic polishing, have been developed in order to solve the above problem. In contrast to the conventional physical machining methods, these methods perform removal processing or the like through a chemical dissolution reaction. Therefore, these methods do not suffer from defects such as formation of an altered layer and dislocation due to plastic deformation, so that processing can be performed without deteriorating the properties of the materials.

In an electrochemical machining process, particularly in an electrochemical machining process using pure water or ultrapure water, an ion exchanger such as an ion exchange membrane or an ion exchange fiber is employed to increase the processing rate. Pure water refers to water having a resistivity of 0.1 MΩ·cm or more at 25° C., and ultrapure water refers to water having a resistivity of 10 MΩ·cm or more at 25° C. Ion exchangers generally comprise an ion exchange resin or an ion exchange membrane in which an ion exchange group, such as a sulfonic acid group, a carboxyl group, a quaternary ammonium group (═N⁺═), or a tertiary or lower amino group, is bonded to a base material, such as a copolymer of styrene and divinylbenzene, or a fluororesin. Further, there has been known an ion exchange fiber in which an ion exchange group is introduced into nonwoven fabric by graft polymerization.

FIG. 2 is a schematic diagram showing an electrolytic processing apparatus using conventional ion exchangers. As shown in FIG. 2, the electrolytic processing apparatus has a power supply 800, an anode (electrode) 810 connected to the power supply 800, and a cathode (electrode) 820 connected to the power supply 800. The anode 810 has an ion exchanger 830 attached to a surface thereof, and the cathode 820 has an ion exchanger 840 attached to a surface thereof. A fluid 860 such as pure water or ultrapure water is supplied between the electrodes 810, 820 and a workpiece 850 (e.g., a copper film). Then, the workpiece 850 is brought into contact with or close to the ion exchangers 830, 840 attached to the surfaces of the electrodes 810, 820. A voltage is applied between the anode 810 and the cathode 820 by the power supply 800. Water molecules in the fluid 860 are dissociated into hydroxide ions and hydrogen ions by the ion exchangers 830, 840. For example, the produced hydroxide ions are supplied to a surface of the workpiece 850. The concentration of the hydroxide ions is thus increased near the workpiece 850, and atoms in the workpiece 850 and the hydroxide ions are reacted with each other to perform removal of a surface layer of the workpiece 850. Thus, the ion exchangers 830, 840 are considered to have catalysis for decomposing water molecules in the fluid 860 into hydroxide ions and hydrogen ions.

However, with respect to the conventional ion exchange resin or ion exchange fiber, when the electrodes 810 and 820 have a small size (i.e., a small diameter), the ion exchangers 830 and 840 cannot be disposed separately on the surfaces of these electrodes 810 and 820. Therefore, the anode 810 and the cathode 820 have to be covered with an ion exchanger extending over both of the anode 810 and the cathode 820.

In such a case, if the distance L₁ between the anode 810 and the cathode 820 is smaller than the distance L₂ between the electrodes 810, 820 and metal (e.g., copper) as the workpiece 850, then an electric current flows between the electrodes 810 and 820 more than between the electrodes 810, 820 and the workpiece 850. Therefore, the distance L₁ between the electrodes 810 and 820 should be set to be larger than the distance L₂ between the electrodes 810, 820 and the workpiece 850.

However, the thicknesses of the ion exchangers 830, 840 prevent the distance L₂ between the electrodes 810, 820 and the workpiece 850 from being sufficiently reduced. Accordingly, the anode 810 and the cathode 820 cannot be disposed as close to each other as would be preferred. As a result, the anode 810 and the cathode 820 have limitations in their shapes or the like.

Further, a conventional ion exchange fiber is problematic in that fibers may be removed from the ion exchanger during an electrolytic process so that the removed fibers cause variations of processing properties according to time elapsed. It has been feared that seams of the fibers may have an influence on the surface roughness of the workpiece. From this point of view, in order to flatten the entire surface of a workpiece, attempts have been made to wind a meshed ion exchange fiber around nonwoven fabric and attach it to a cylindrical electrode. However, when an ion exchanger has an uneven thickness, the flatness of the surface of the workpiece may be influenced by the uneven thickness of the ion exchanger.

### DISCLOSURE OF INVENTION

The present invention has been made in view of the above drawbacks. It is, therefore, a first object of the present invention to provide an electrolytic processing apparatus which can achieve stable processing performance and can flexibly cope with small electrodes and various shapes of electrodes.

A second object of the present invention is to provide a substrate processing apparatus having such an electrolytic processing apparatus.

In order to attain the first object, according to a first aspect of the present invention, there is provided an electrolytic processing apparatus having at least one processing electrode and at least one feeding electrode disposed on the same side as the processing electrode with respect to a workpiece. An organic compound having an ion exchange group is chemically bonded to at least one of a surface of the processing electrode and a surface of the feeding electrode to form an ion exchange material. The electrolytic processing apparatus also has a workpiece holder for holding the workpiece and bringing the workpiece into contact with or close to the processing electrode. The electrolytic processing apparatus includes a power supply for applying a voltage between the processing electrode and the feeding electrode, and a fluid supply unit for supplying a fluid between the workpiece and the processing electrode. The term “on the same side as the processing electrode with respect to the workpiece” means that when a conductive film is formed on a surface of the substrate, the conductive film is to be fed (or supplied with electric power) by the feeding electrode and to be brought into contact with or close to the processing electrode. The present invention covers cases where the conductive film is fed through a bevel portion of the workpiece. Thus, the present invention is applicable to electrolytic processing of device wafers having semiconductor devices, circuits, or conductive films formed on a surface thereof.

FIG. 3 shows an ionic state when anion exchange material 12a, in which an organic compound having an ion exchange group is chemically bonded to a surface of a processing electrode 14 (conductive material), and an ion exchange material 12b, in which an organic compound having an ion exchange group is chemically bonded to a surface of a feeding electrode 16 (conductive material), are brought into contact with or close to a surface of a workpiece 10. A voltage is applied between the processing electrode 14 and the feeding electrode 16 by a power supply 17, and a fluid 18 such as ultrapure water is supplied from a fluid supply unit 19 between the processing electrode 14, the feeding electrode 16, and the workpiece 10. FIG. 4 shows an ionic state when the ion exchange material 12a formed on the processing electrode 14 is brought into contact with or close to the surface of the workpiece 10, and the feeding electrode 16 is brought into direct contact with the workpiece 10 to feed the workpiece 10. A voltage is applied between the processing electrode 14 and the feeding electrode 16 by the power supply 17, and the fluid 18 such as ultrapure water is supplied from the fluid supply unit 19 between the processing electrode 14 and the workpiece 10.

In the case where liquid such as ultrapure water, which has a large resistivity, is used, it is desirable that the workpiece 10 is brought into contact with or close to the ion exchange material 12a, because it is possible to reduce the electric resistance, the requisite voltage, and hence the power consumption.

Water molecules 20 in the fluid 18, such as ultrapure water, are dissociated efficiently into hydroxide ions 22 and hydrogen ions 24 by the ion exchange materials 12a and 12b. The hydroxide ions 22 thus produced, for example, are supplied to the surface of the workpiece 10 facing the processing electrode 14 by the electric field between the workpiece 10 and the processing electrode 14 and by the flow of the fluid 18. The concentration of the hydroxide ions is thus increased near the workpiece 10 to react the hydroxide ions 22 with atoms 10a in the workpiece 10. Reaction products 26 produced by this reaction are dissolved in the fluid 18 and removed from the workpiece 10 by the flow of the fluid 18 along the surface of the workpiece 10. In this manner, a removal process is performed on the surface of the workpiece 10.

Thus, the removal process according to the present invention employs a purely electrochemical interaction between the reactant ions and the workpiece and clearly differs in the processing principle from CMP, which employs a combination of a physical interaction between a polishing tool and a workpiece and a chemical interaction between a chemical species in a polishing liquid and the workpiece. According to the removal process according to the present invention, the workpiece 10 is processed at a portion facing the processing electrode 14. Therefore, the workpiece 10 can be processed into a desired surface configuration by moving the processing electrode 14.

As described above, the electrolytic processing apparatus according to the present invention employs only a dissolution reaction due to an electrochemical interaction and clearly differs in the processing principle from a CMP apparatus, which employs a combination of a physical interaction between a polishing tool and a workpiece and a chemical interaction between a chemical species in a polishing liquid and the workpiece. Therefore, the removal process can be performed without deteriorating the properties of materials. Even if the workpiece is formed by a material having a low mechanical strength, such as the aforementioned low-k material, the removal process can be performed without any physical damage to the workpiece. Further, when a fluid having an electric conductivity of 500 μS/cm or less, preferably pure water, more preferably ultrapure water, is used as a processing liquid instead of an electrolytic solution used in a conventional electrolytic process, it is possible to remarkably reduce contamination of a surface of the workpiece and to easily treat waste liquid after the electrolytic process.

According to present invention, the ion exchange material having an ion exchange function can be formed directly on the electrode. Therefore, it is possible to reduce the distance between the electrode and the workpiece. Accordingly, it is possible to reduce the distance between the anode and the cathode. Thus, the electrolytic processing apparatus according to the present invention can flexibly cope with small electrodes and various shapes of electrodes. Further, because ion exchange materials can be formed separately on the cathode and the anode, a leakage current can be prevented from being produced between the cathode and the anode.

The organic compound may comprise thiol or disulfide. The ion exchange group may comprise at least one of a sulfonic acid group, a carboxyl group, a quaternary ammonium group, and an amino group. The conductive material may include at least one of gold, silver, platinum, copper, gallium arsenide, cadmium sulfide, and indium oxide (III).

According to a second aspect of the present invention, there is provided an electrolytic processing apparatus having at least one processing electrode and at least one feeding electrode disposed on the same side as the processing electrode with respect to a workpiece. At least one of the processing electrode and the feeding electrode comprises a conductive carbon material and an ionic dissociation functional group chemically modifying a surface of the conductive carbon material. The electrolytic processing apparatus also has a workpiece holder for holding the workpiece and bringing the workpiece into contact with or close to the processing electrode. The electrolytic processing apparatus includes a power supply for applying a voltage between the processing electrode and the feeding electrode, and a fluid supply unit for supplying a fluid between the workpiece and the processing electrode.

The ionic dissociation functional group may comprise a carboxyl group. The ionic dissociation functional group may comprise at least one of a quaternary ammonium group, and a tertiary or lower amino group. The conductive carbon material may comprise glassy carbon, fullerene, or carbon nanotubes.

According to a third aspect of the present invention, there is provided an electrolytic processing apparatus having at least one processing electrode and at least one feeding electrode disposed on the same side as the processing electrode with respect to a workpiece. At least one of the processing electrode and the feeding electrode comprises a graphite intercalation compound containing alkali metal. The electrolytic processing apparatus also has a workpiece holder for holding the workpiece and bringing the workpiece into contact with or close to the processing electrode. The electrolytic processing apparatus includes a power supply for applying a voltage between the processing electrode and the feeding electrode, and a fluid supply unit for supplying a fluid between the workpiece and the processing electrode.

The fluid may comprise pure water, ultrapure water, a liquid having an electric conductivity of 500 μS/cm or less, or an electrolytic solution having an electric conductivity of 500 μS/cm or less.

The electrolytic processing apparatus may have a driving mechanism operable to move the workpiece and at least one of the processing electrode and the feeding electrode relative to each other to provide a relative movement between the workpiece and at least one of the processing electrode and the feeding electrode. The relative movement may comprise a rotational movement, a reciprocating movement, an eccentric rotational movement, a scroll movement, or a combination of these movements. The relative movement may comprise a movement along a surface of the workpiece.

The processing electrode and the feeding electrode may be disposed in a spaced relationship. The organic compound having the ion exchange group may be bonded separately to the processing electrode and the feeding electrode.

The electrolytic processing apparatus may have an electrode unit having the processing electrode, the feeding electrode, and the fluid supply unit.

The processing electrode may comprise a plurality of processing electrodes, and the feeding electrode may comprise a plurality of feeding electrodes. In this case, the plurality of processing electrodes and the plurality of feeding electrodes may alternately be disposed on the same side of the workpiece.

One of the processing electrode and the feeding electrode may be disposed so as to surround the other of the processing electrode and the feeding electrode.

The feeding electrode may comprise a plurality of feeding electrodes provided at a peripheral portion of the processing electrode.

The processing electrode may comprise a plurality of processing electrodes disposed in parallel with each other at equal intervals.

In order to attain the second object, according to a fourth aspect of the present invention, there is provided a substrate processing apparatus having a loading and unloading section for loading and unloading a substrate, the above electrolytic processing apparatus, and a cleaning device for cleaning the substrate. The substrate processing apparatus also has a transfer device for transferring the substrate between the loading and unloading section, the electrolytic processing apparatus, and the cleaning device. The substrate processing apparatus may have a CMP apparatus for chemical mechanical polishing a surface of the substrate.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIGS. 1A through 1C are diagrams showing an example of a process of forming a copper interconnection in a substrate;

FIG. 2 is a schematic diagram showing a conventional electrolytic processing apparatus using ion exchangers;

FIG. 3 is a diagram illustrating the principle of electrolytic processing according to the present invention, in which a processing electrode having an ion exchange material and a feeding electrode having an ion exchange material are brought close to a substrate (workpiece), and pure water or a fluid having an electric conductivity of 500 μS/cm or less is supplied between the processing electrode, the feeding electrode, and the substrate (workpiece);

FIG. 4 is a diagram illustrating the principle of electrolytic processing according to the present invention, in which an ion exchange material is formed only on a processing electrode, and a fluid is supplied between the processing electrode and the substrate (workpiece);

FIG. 5 is a plan view showing a substrate processing apparatus according to a first embodiment of the present invention;

FIG. 6 is a plan view schematically showing an electrolytic processing apparatus in the substrate processing apparatus shown in FIG. 5;

FIG. 7 is a cross-sectional view of FIG. 6;

FIG. 8A is a plan view showing rotation-prevention mechanisms shown in FIG. 6;

FIG. 8B is a cross-sectional view taken along line A-A of FIG. 8A;

FIG. 9 is a plan view showing an electrode unit in the electrolytic processing apparatus shown in FIG. 6;

FIG. 10 is a cross-sectional view taken along line B-B of FIG. 9;

FIG. 11 is an enlarged view of FIG. 10;

FIGS. 12A and 12B are graphs showing the current-voltage properties when an electrolysis process was performed with use of an ion exchange material in which an organic compound having an ion exchange group was chemically bonded to an electrode;

FIG. 13 is a vertical cross-sectional view schematically showing an electrolytic processing apparatus according to a second embodiment of the present invention;

FIG. 14 is a plan view of FIG. 13;

FIG. 15 is a plan view showing an electrode unit in the electrolytic processing apparatus shown in FIG. 13;

FIG. 16 is an enlarged view of FIG. 15;

FIG. 17 is a vertical cross-sectional view schematically showing an electrolytic processing apparatus according to a third embodiment of the present invention;

FIG. 18 is a vertical cross-sectional view schematically showing a substrate holder and an electrode unit in the electrolytic processing apparatus shown in FIG. 17;

FIG. 19 is a plan view showing the relationship between the electrode unit shown in FIG. 18 and a substrate;

FIG. 20 is a plan view showing a variation of the electrode unit in the third embodiment;

FIG. 21 is a perspective view showing another variation of the electrode unit in the third embodiment;

FIG. 22 is a plan view showing another variation of the electrode unit in the third embodiment;

FIG. 23 is a plan view showing a substrate processing apparatus according to a fourth embodiment of the present invention;

FIG. 24 is a schematic view showing a CMP apparatus in the substrate processing apparatus shown in FIG. 23;

FIG. 25 is a schematic diagram showing an electrolytic processing apparatus having another type of electrode according to the present invention;

FIG. 26 is a graph showing the current-voltage properties of the electrode shown in FIG. 25;

FIG. 27 is a graph showing the current-voltage properties of the electrode shown in FIG. 25;

FIG. 28 is a schematic diagram showing an electrolytic processing apparatus having another type of electrode according to the present invention;

FIG. 29 is a schematic diagram showing an experimental device used to measure the current-voltage properties of an electrode to be used in an electrolytic processing apparatus according to the present invention; and

FIG. 30 is a graph showing the current-voltage properties of the electrode shown in FIG. 28, which are measured by the experimental device shown in FIG. 29.

### BEST MODE FOR CARRYING OUT THE INVENTION

An electrolytic processing apparatus and a substrate processing apparatus having the electrolytic processing apparatus according to embodiments of the present invention will be described below with reference to the accompanying drawings. In the following embodiments, a substrate is used as a workpiece and processed by an electrolytic processing apparatus. However, the present invention is applicable to any workpiece other than the substrate.

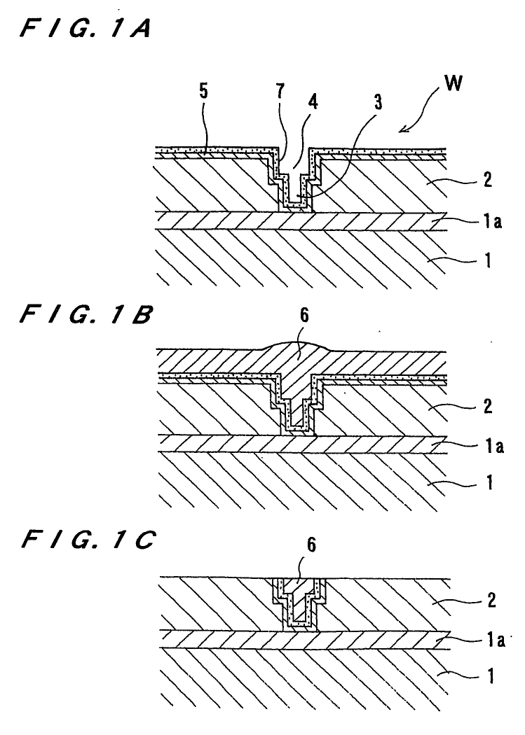

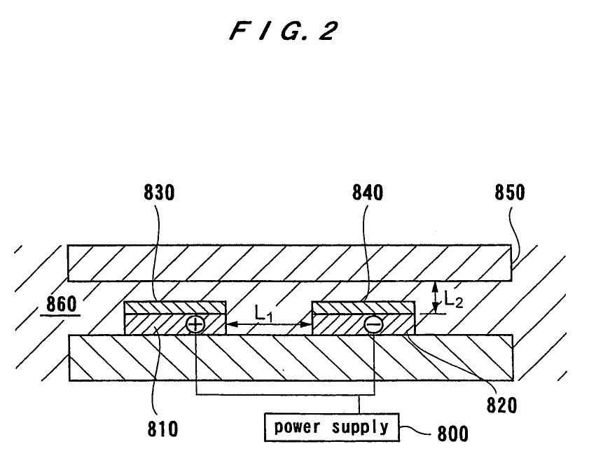

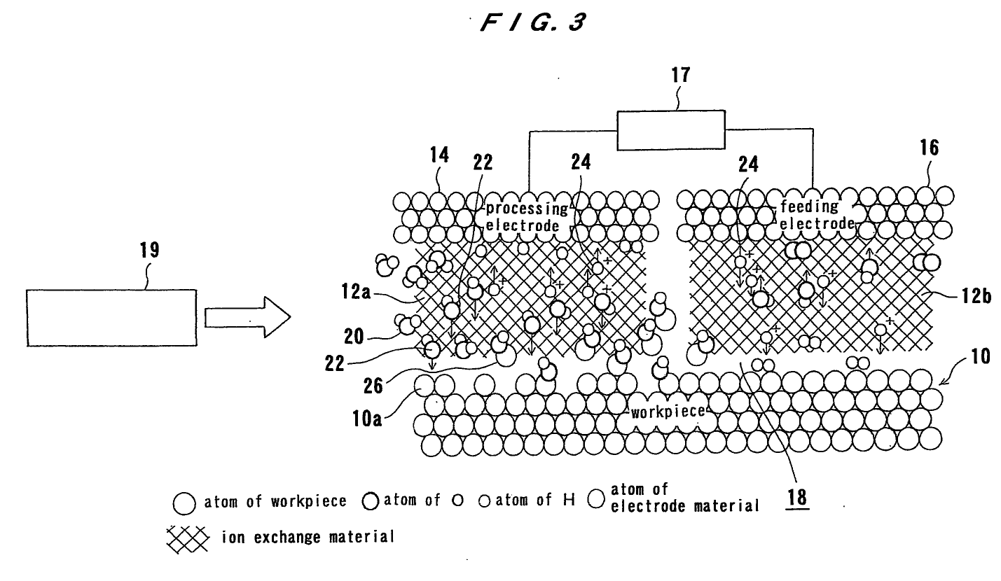

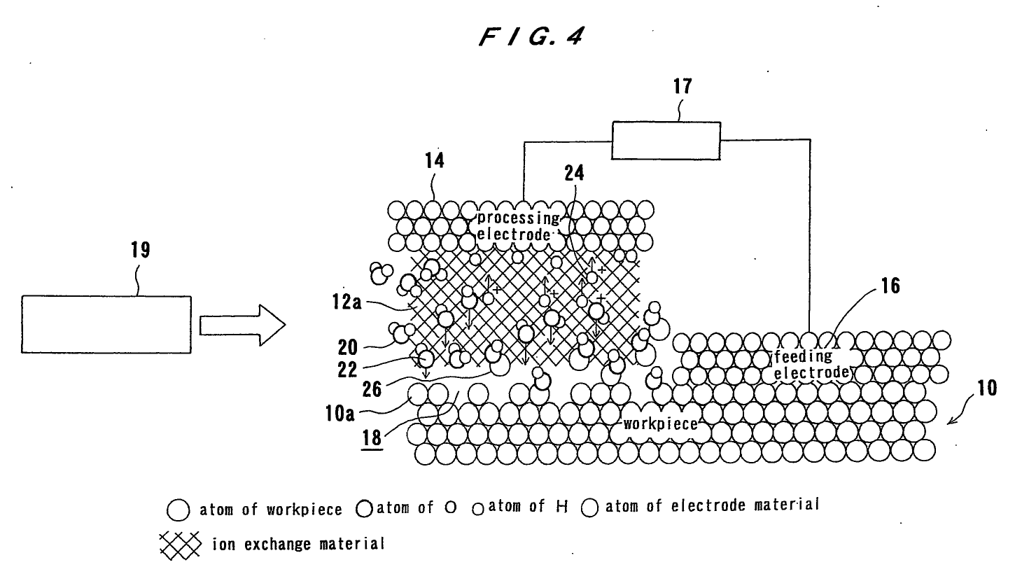

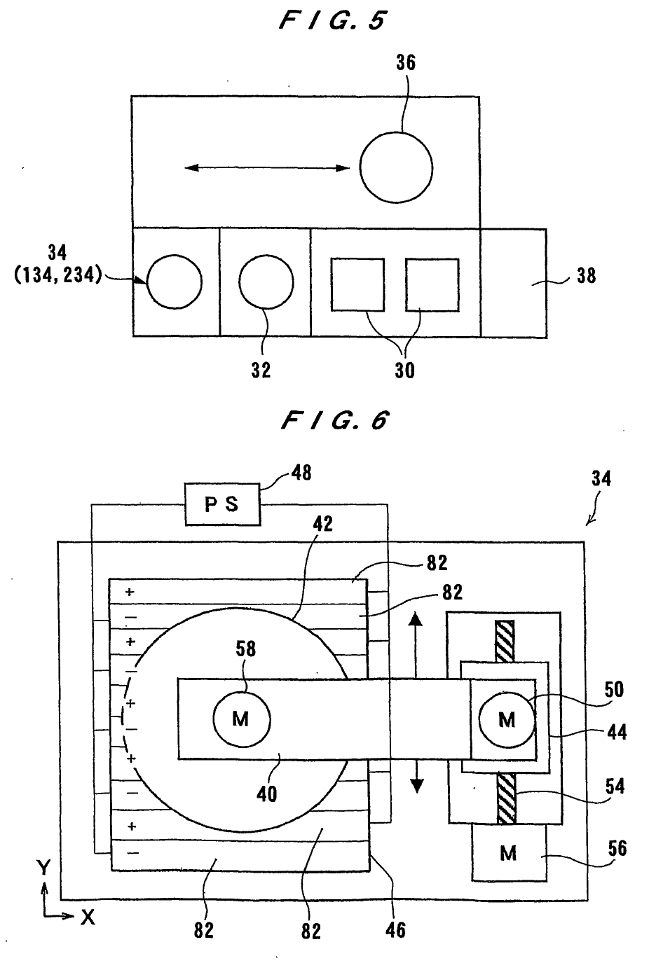

FIG. 5 is a plan view showing a substrate processing apparatus according to a first embodiment of the present invention. As shown in FIG. 5, the substrate processing apparatus has a pair of loading/unloading units 30, a reversing machine 32 for reversing a substrate, and an electrolytic processing apparatus 34. The loading/unloading units 30 serve as a loading and unloading section for loading and unloading a cassette accommodating the substrates. For example, as shown in FIG. 1B, the substrate W to be processed has a copper film 6 formed as a conductive film on a surface thereof. The processing devices including the loading/unloading units 30, the reversing machine 32, and the electrolytic processing apparatus 34 are disposed in series within the substrate processing apparatus. The substrate processing apparatus also has a transfer robot 36 disposed adjacent to the processing devices. The transfer robot 36 is movable in a direction parallel to the array of the processing devices. The transfer robot 36 serves as a transfer device for receiving and delivering a substrate W between these processing devices. The substrate processing apparatus also has a monitoring unit 38 disposed adjacent to the loading/unloading units 30 for monitoring a voltage applied between a processing electrode and a feeding electrode or a current flowing therebetween when the electrolytic processing apparatus 34 performs an electrolytic process. The substrate processing apparatus may have a device for cleaning and drying a substrate after the electrolytic process so that the substrate is returned to the loading/unloading unit 30 in a clean and dry state.

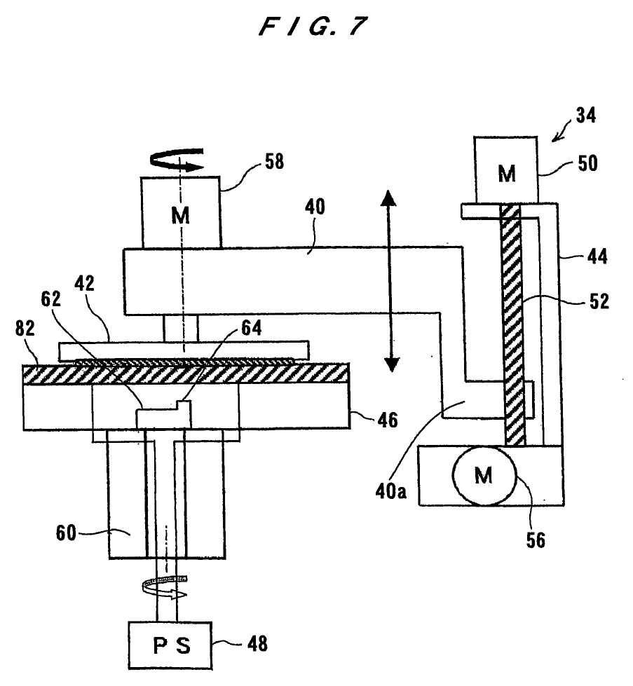

FIG. 6 is a plan view showing the electrolytic processing apparatus 34 in the substrate processing apparatus, and FIG. 7 is a cross-sectional view of FIG. 6. As shown in FIGS. 6 and 7, the electrolytic processing apparatus 34 has an arm 40, a substrate holder 42 supported at a free end of the arm 40 for attracting and holding the substrate in a state in which the substrate faces downward (face-down), a movable frame 44 on which the arm 40 is mounted, a rectangular electrode unit 46, and a power supply 48 connected to the electrode unit 46. The arm 40 is vertically movable and can reciprocate on the horizontal plane. In the present embodiment, the electrode unit 46 has a size larger than the diameter of the substrate held by the substrate holder 42.

As shown in FIGS. 6 and 7, the electrolytic processing apparatus 34 has a vertical movement motor 50 disposed at an upper end of the movable frame 44 for vertically moving the arm 40, and a vertically extending ball screw 52 coupled to the vertical movement motor 50. The arm 40 has a base portion 40a attached to the ball screw 52. When the vertical movement motor 50 is actuated, the arm 40 is vertically moved via the ball screw 52. As shown in FIG. 6, the movable frame 44 is attached to a horizontally extending ball screw 54 coupled to a horizontal movement motor 56. When the horizontal movement motor 56 is actuated, the movable frame 44 and the arm 40 are horizontally moved via the ball screw 54.

The substrate holder 42 is coupled to a rotation motor 58 provided on an upper surface of the free end of the arm 40. The rotation motor 58 serves as a first driving mechanism to move the substrate held by the substrate holder 42 and the electrode unit 46 relative to each other. When the rotation motor 58 is actuated, the substrate holder 42 is rotated. The substrate holder 42 may not be rotated continuously and may be rotated intermittently by the rotation motor 58 so as to change the angular direction of the substrate holder 42. Since the arm 40 is vertically and horizontally movable as described above, the substrate holder 42 can be vertically and horizontally moved together with the arm 40.

As shown in FIG. 7, the electrolytic processing apparatus 34 has a hollow motor 60 disposed below the electrode unit 46. The hollow motor 60 serves as a second driving mechanism to move the substrate held by the substrate holder 42 and the electrode unit 46 relative to each other. The hollow motor 60 has a main shaft 62, and the main shaft 62 has a driving end 64 provided on an upper end of the main shaft 62 at an eccentric position to the center of the main shaft 62. The electrode unit 46 is rotatably coupled to the driving end 64 of the hollow motor 60 at the center of the electrode unit 46 via a bearing (not shown). Three or more rotation-prevention mechanisms are provided between the electrode unit 46 and the hollow motor 60 along a circumferential direction.

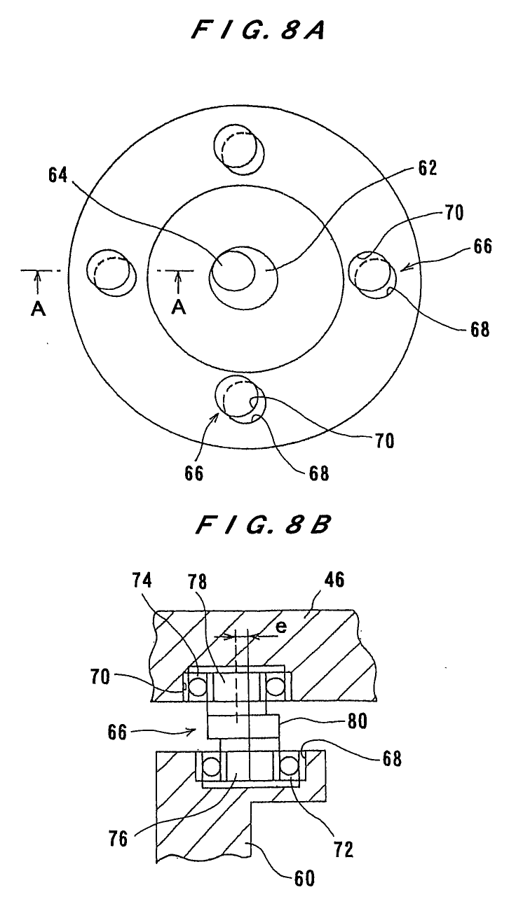

FIG. 8A is a plan view showing the rotation-prevention mechanisms in the present embodiment, and FIG. 8B is a cross-sectional view taken along line A-A of FIG. 8A. As shown in FIGS. 8A and 8B, three or more rotation-prevention mechanisms 66 are provided between the electrode unit 46 and the hollow motor 60 along the circumferential direction. In the example shown in FIG. 8A, four rotation-prevention mechanisms 66 are provided. As shown in FIG. 8B, a plurality of depressions 68, 70 are formed at equal intervals along the circumferential direction at the corresponding positions in an upper surface of the hollow motor 60 and in a lower surface of the electrode unit 46. The depressions 68 and 70 have bearings 72 and 74 provided therein, respectively. The bearings 72 and 74 receive respective ends of two shafts 76 and 78, respectively. The two shafts 76 and 78 are eccentric to each other by a distance “e”. The respective other ends of the shafts 76 and 78 are connected to each other via a connecting member 80. The driving end 64 is eccentric to the center of the main shaft 62 of the hollow motor 60 by a distance, which is the same as the above distance “e”. Accordingly, when the hollow motor 60 is actuated, the electrode unit 46 makes a revolutionary movement, the radius of which is the distance “e” between the center of the main shaft 62 and the driving end 64, about the center of the main shaft 62 without rotation about its own axis. Specifically, the electrode unit 46 makes a so-called scroll movement (translational rotation movement).

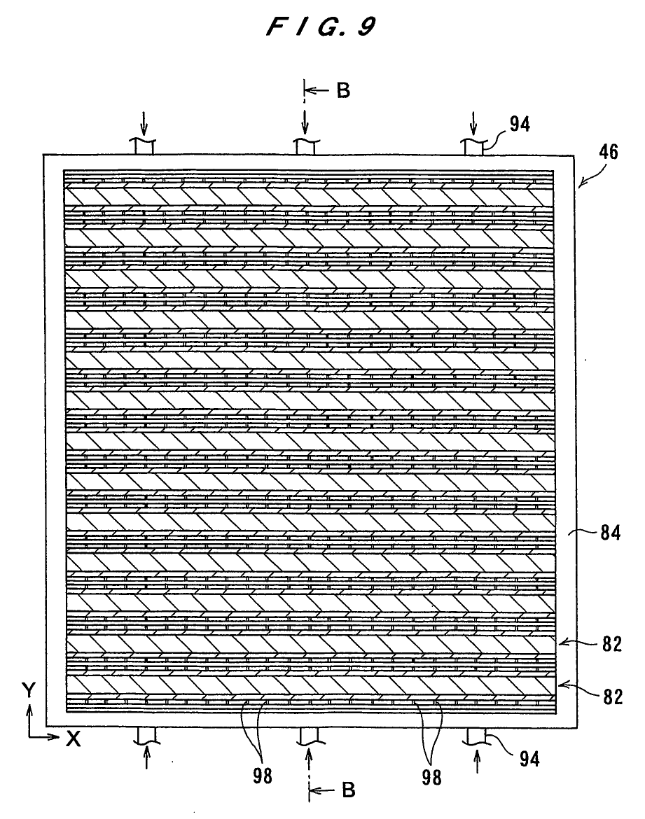

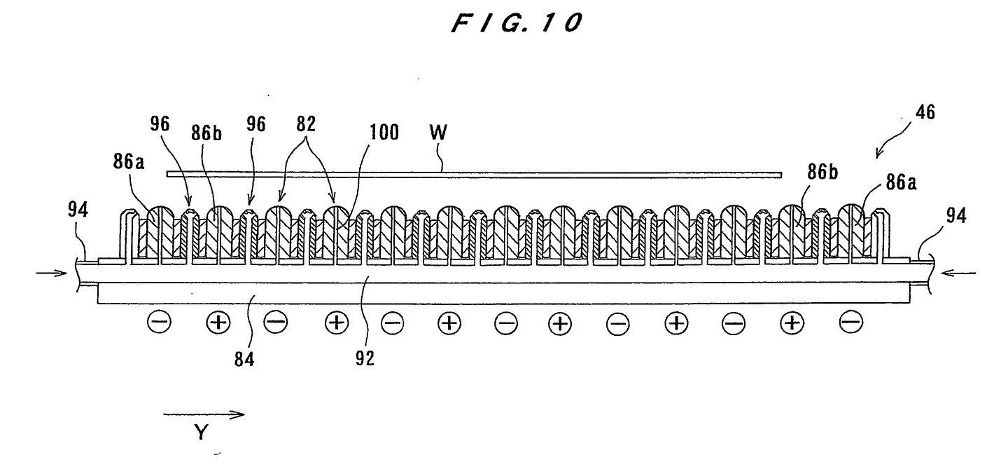

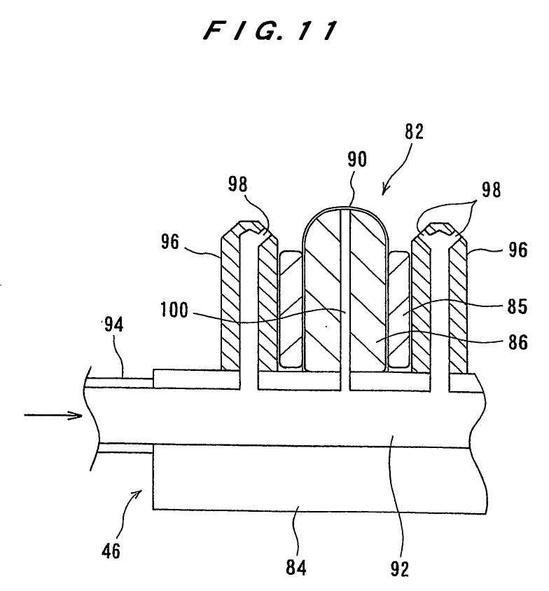

Next, the electrode unit 46 in the present embodiment will be described below. As shown in FIG. 6, the electrode unit 46 has a plurality of electrode members 82. FIG. 9 is a plan view showing the electrode unit 46 in the present embodiment, FIG. 10 a cross-sectional view taken along line B-B of FIG. 9, and FIG. 11 an enlarged view of FIG. 10. As shown in FIGS. 9 and 10, the electrode unit 46 has a plurality of electrode members 82 extending in an X direction (see FIGS. 6 and 9). The electrode members 82 are arranged in parallel with each other at equal pitch. As shown in FIG. 11, each of the electrode members 82 has plates 85 disposed on both sides thereof.

As shown in FIG. 11, each of the electrode members 82 has an electrode 86 made of a conductive material. An organic compound having an ion exchange group is chemically bonded to a surface of the electrode 86 to form an ion exchange material 90 on the surface of the electrode 86. Specifically, the electrode member 82 comprises an ion exchanger formed by chemically bonding an organic compound having an ion exchange group to the surface of the electrode 86. The details of the ion exchanger will be described later.

In the present embodiment, the electrodes 86 of adjacent electrode members 82 are connected alternately to a cathode and an anode of the power supply 48 (see FIGS. 6 and 7). For example, an electrode 86a (see FIG. 10) is connected to the cathode of the power supply 48, and an electrode 86b (see FIG. 10) is connected to the anode of the power supply 48. When copper is to be processed, an electrolytic effect is developed on the cathode. Accordingly, the electrode 86a connected to the cathode forms a processing electrode, and the electrode 86b connected to the anode forms a feeding electrode. Thus, in the present embodiment, the feeding electrodes are provided on the same side as the processing electrodes with respect to the substrate W. Further, the processing electrodes and the feeding electrodes are alternately disposed at equal intervals.

Depending upon a material to be processed, the electrode connected to the cathode of the power supply 48 may form a feeding electrode, and the electrode connected to the anode of the power supply 48 may form a processing electrode. Specifically, when a material to be processed is copper, molybdenum, iron, or the like, an electrolytic effect is developed on the cathode. Accordingly, the electrode 86a connected to the cathode forms a processing electrode, and the electrode 86b connected to the anode forms a feeding electrode. When a material to be processed is aluminum, silicon, or the like, an electrolytic effect is developed on the anode. Accordingly, the electrode 86b connected to the anode forms a processing electrode, and the electrode 86a connected to the cathode forms a feeding electrode.

As described above, the processing electrodes and the feeding electrodes are arranged alternately in a Y direction of the electrode unit 46, which is perpendicular to a longitudinal direction of the electrode members 82. Accordingly, it is not necessary to provide a feeding portion to feed electric power to a conductive film (a material to be processed) on the substrate W. Therefore, the substrate W can be processed over the entire surface thereof without any unprocessed portions caused by a feeding portion. Further, when a voltage applied between the electrodes 86 is varied between a positive value and a negative value in a pulsed manner, it is possible to dissolve products due to the electrolytic process to improve the flatness of the substrate W through multiple repeated processes. Alternatively, the voltage applied between the electrodes 86 may be varied between a positive value and zero in a pulsed manner or varied between a negative value and zero in a pulsed manner.

As shown in FIG. 10, the electrode unit 46 has a base 84 supporting the electrode members 82. The base 84 has a passage 92 formed therein. The passage 92 serves as a fluid supply unit for supplying fluid (pure water or ultrapure water) to the surface of the substrate W. The passage 92 is connected to a pure water supply source (not shown) through a pure water supply pipe 94. On both sides of each electrode member 82, pure water ejection nozzles 96 are provided for ejecting pure water or ultrapure water, which is supplied through the passage 92 to between the substrate W and the ion exchange material 90 of the electrode member 82. Each of the pure water ejection nozzles 96 has ejection slots 98 disposed at a plurality of locations (see FIG. 9) along the X direction for ejecting pure water or ultrapure water toward the surface of the substrate W which faces the electrode members 82, i.e., toward contacting portions of the substrate W and the ion exchange materials 90. Pure water or ultrapure water in the passage 92 is supplied to the entire area of the surface of the substrate W from the ejection slots 98 in the pure water ejection nozzles 96.

As shown in FIG. 11, the height of the pure water ejection nozzles 96 is less than those of the ion exchange materials 90 of the electrode members 82. Accordingly, even if the substrate W is brought into contact with the ion exchange materials 90 of the electrode members 82, the substrate W cannot be brought into contact with the pure water ejection nozzles 90.

Each of the electrodes 86 in the electrode members 82 has through-holes 100 extending through the electrode 86 from the passage 92 to the ion exchange material 90. Thus, pure water or ultrapure water in the passage 92 is supplied through the through-holes 100 to the ion exchange materials 90. Pure water refers to water having an electric conductivity of 10 μS/cm or less, and ultrapure water refers to water having an electric conductivity of 0.1 μS/cm or less. The use of pure water or ultrapure water, which contains substantially no electrolyte, can prevent undesired impurities such as an electrolyte from adhering to and remaining on the surface of the substrate W when the electrolytic process is performed. Further, copper ions or the like dissolved by the electrolytic process are immediately captured by the ion exchange materials 90 through an ion exchange reaction. Therefore, the dissolved copper ions or the like can be prevented from re-precipitating on other portions of the substrate W or from being oxidized to become fine particles which contaminate the surface of the substrate W.

Instead of pure water or ultrapure water, it is possible to use a liquid having an electric conductivity of 500 μS/cm or less, or any electrolytic solution. For example, an electrolytic solution prepared by adding an electrolyte to pure water or ultrapure water may be used instead of pure water or ultrapure water. The use of such an electrolytic solution can lower an electric resistance and reduce power consumption. A solution of a neutral salt such as NaCl or Na₂SO₄, a solution of an acid such as HCl or H₂SO₄, or a solution of an alkali such as ammonia, may be used as the electrolytic solution. These solutions may selectively be used according to the properties of the workpiece.

Further, instead of pure water or ultrapure water, it is also possible to use a liquid prepared by adding a surfactant or the like to pure water or ultrapure water so as to have an electric conductivity of 500 μS/cm or less, preferably 50 μS/cm or less, more preferably 0.1 μS/cm or less (resistivity of 10 MΩ·cm or more). Due to the presence of a surfactant in pure water or ultrapure water, the liquid can form a layer, which functions to evenly inhibit ion migration, at interfaces between the substrate W and the ion exchange materials 90. Therefore, locally concentrated ion exchange (metal dissolution) can be moderated to enhance the flatness of the processed surface. The surfactant should preferably have a concentration of 100 ppm or less. When the electric conductivity is too high, the current efficiency is lowered and the processing rate is lowered. The use of the liquid having an electric conductivity of 500 μS/cm or less, preferably 50 μS/cm or less, more preferably 0.1 μS/cm or less, can attain a desired processing rate.

Next, operation (electrolytic processing) with the substrate processing apparatus in the present embodiment will be described below. First, a cassette accommodating substrates W is placed on one of the loading/unloading units 30. For example, as shown in FIG. 1B, the substrate W to be processed has a copper film 6 formed as a conductive film on a surface thereof. One of the substrates W is picked up from the cassette by the transfer robot 36. The transfer robot 36 transfers the substrate W to the reversing machine 32, as needed. By the reversing machine 32, the substrate W is turned upside down so that a surface of the substrate W having a conductive film (copper film 6) faces downward.

The transfer robot 36 receives the reversed substrate W and transfers it to the electrolytic processing apparatus 34. The substrate W is then attracted and held by the substrate holder 42 of the electrolytic processing apparatus 34. The substrate holder 42 holding the substrate W is moved to a processing position, which is located right above the electrode unit 46, by moving the arm 40. The substrate holder 42 is then lowered by the actuation of the vertical movement motor 50 so that the substrate W held by the substrate holder 42 is brought into contact with or close to the surfaces of the ion exchange materials 90 in the electrode unit 46. Then, the rotational motor 58 is actuated to rotate the substrate holder 42 and the substrate W, and the hollow motor 60 is actuated so that the electrode unit 46 makes a scroll movement. Thus, the substrate W and the electrode unit 46 are moved relative to each other. The substrate holder 42 may not be rotated continuously and may be rotated intermittently by the rotation motor 58 so as to change the angular direction of the substrate holder 42. At that time, pure water or ultrapure water is ejected between the substrate W and the electrode members 82 from the ejection slots 98 of the pure water ejection nozzles 96. Further, pure water or ultrapure water is impregnated into the ion exchange materials 90 through the through-holes 100 of the electrodes 86. In the present embodiment, pure water or ultrapure water supplied to the ion exchange materials 90 is discharged from longitudinal ends of the respective electrode members 82.

Then, a predetermined voltage is applied between the processing electrodes and the feeding electrodes by the power supply 48 to produce hydrogen ions and hydroxide ions by the ion exchange materials 90. Thus, the conductive film (copper film 6), which is formed on the surface of the substrate W, is subjected to an electrolytic process through the action of the hydrogen ions or the hydroxide ions on the processing electrodes (e.g., cathodes).

After completion of the electrolytic process, the power supply 48 is disconnected, and the rotation of the substrate holder 42 and the scroll movement of the electrode unit 46 are stopped. Thereafter, the substrate holder 42 is lifted and moved by the arm 40 to deliver the substrate W to the transfer robot 36. The transfer robot 36 receives the substrate W from the substrate holder 42 and transfers it to the reversing machine 32, as needed. By the reversing machine 32, the substrate W is turned upside down. Then, the transfer robot 36 returns the substrate W to the cassette on the loading/unloading unit 30.

In the case where liquid such as ultrapure water, which has a large resistivity, is used, it is possible to reduce the electric resistance by bringing the substrate W into contact with or close to the ion exchange materials 90. Therefore, the requisite voltage can be lowered, and hence the power consumption can be reduced. When the substrate W is brought into contact with the ion exchange materials 90, such contact intends that the electrodes approach the substrate W as close as possible, but not that the electrodes press on the substrate W to provide a physical energy or stress to the workpiece, as in CMP. Accordingly, the electrolytic processing apparatus 34 in the present embodiment employs the vertical movement motor 50 to bring the substrate W into contact with or close to the electrode unit 46, and does not have a pressing mechanism such as usually employed in a CMP apparatus that positively presses a substrate against a polishing tool. Specifically, a CMP apparatus generally presses a substrate against a polishing surface under a pressure of about 20-50 kPa, whereas the electrolytic processing apparatus 34 in the present embodiment can bring the substrate W into contact with the ion exchange materials 90 under a pressure of 20 kPa or less. Even under a pressure 10 kPa or less, a sufficient removal effect can be achieved by the electrolytic processing apparatus 34.

As described above, in the present embodiment, each of the electrode members 82 has the ion exchange material 90 in which an organic compound having an ion exchange group is chemically bonded to the electrode 86 (conductive material). The term “bond” means that a material having an ion exchange group is bonded to a conductive material by chemical bond, not by an adhesive or the like. In a usual ion exchange resin, a material having an ion exchange group is “bonded” to an organic matter included in the resin.

It is desirable that the conductive material to which an organic compound is bonded has meshes, e.g., a lattice pattern or a form of a punching metal, because such meshes can allow water to pass therethrough to decompose water efficiently.

Such an electrode can be produced as follows. There will be described an example in which sodium 1-propanethiol-3-sulfonate (HSC₃H₆—SO₃Na) was used as an organic compound having an ion exchange group and was bonded directly to a platinum (Pt) substrate to produce an electrode. A sodium salt of sulfonic acid group is substituted at the 3-end of 1-propanethiol to form sodium 1-propanethiol-3-sulfonate (thiol).

First, a flat platinum substrate, for example, having a length of 34 mm, a width of 12.5 mm, and a thickness of 0.5 mm, was prepared. An organic matter on a surface of the platinum substrate was removed by a sulfuric acid and hydrogen peroxide aqueous solution. Then, the platinum substrate was immersed in an aqueous solution of sodium 1-propanethiol-3-sulfonate, which had a concentration of several milimoles/liter, for about 12 hours. Sodium 1-propanethiol-3-sulfonate has hydrophilicity under the influence of a sulfonic acid group as a functional group. Therefore, while the surface of the platinum substrate was hydrophobic before the immersion, the surface of the platinum substrate became hydrophilic after the immersion so that thiol is bonded to the surface of the platinum substrate. Thus, a flat platinum electrode (Pt—SC₃H₆—SO₃Na), which has a catalyst (an ion dissociation function), could be produced.

The catalysis in dissolution reactions of water molecules was measured on the platinum electrode modified by sodium 1-propanethiol-3-sulfonate, which is hereinafter referred to as a thiol platinum electrode. Specifically, a thiol platinum electrode produced as described above was installed into an experimental device having parallel plate electrodes, and electrolysis was performed with ultrapure water. The current-voltage properties were measured for the following cases. Further, the current-voltage properties were measured for a comparative experiment in which normal platinum electrodes were used as an anode and a cathode.

(1) A thiol platinum electrode was used as an anode, and a normal platinum electrode was used as a cathode.

(2) A normal platinum electrode was used as an anode, and a thiol platinum electrode was used as a cathode.

A fluororesin sheet was disposed between the electrodes. Areas of the electrodes facing each other were set to be about 0.4 cm². The distance between the electrodes was adjusted by the thickness of the fluororesin sheet. Measurements were conducted under two conditions in which the distance between the electrodes was 50 μm and 12 μm.

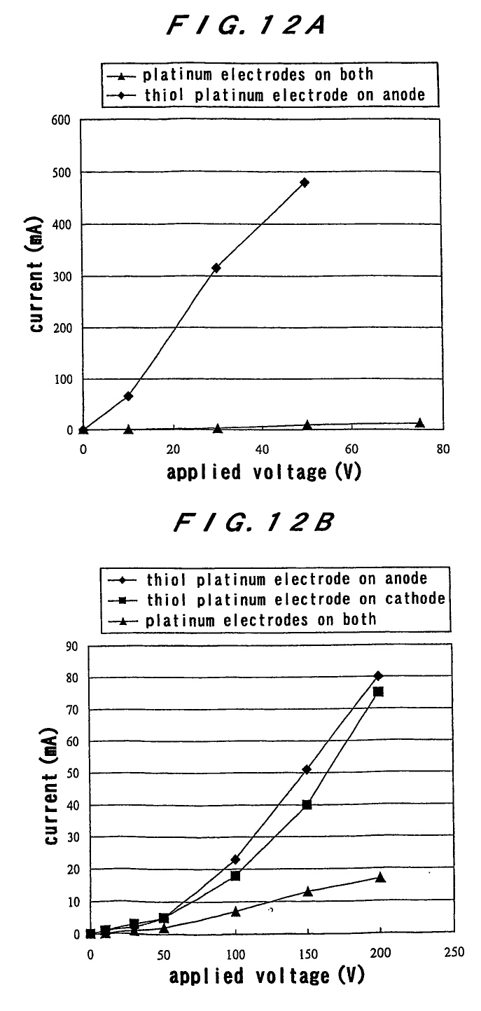

FIG. 12A is a graph showing results of an experiment in which the distance between the electrodes was 12 μm, and FIG. 12B is a graph showing results of an experiment in which the distance between the electrodes was 50 μm. It can be shown from FIGS. 12A and 12B that when a thiol platinum electrode was used as an anode or a cathode, the electrolytic current was increased by several times to several tens of times (50 times at maximum) as compared to a case where normal platinum electrodes were used as an anode and a cathode. Thus, the thiol platinum electrode served as a catalyst for dissociating water into ions. A liquid in which the dissociation is promoted is not limited to water.

It can be seen from FIGS. 12A and 12B that an increase of electrolytic current was larger as the distance between the electrodes was smaller. Specifically, when the distance between the electrodes was 12 μm, the electrolytic current value was about 50 times as large as that in the case of using the normal platinum electrodes (see FIG. 12A). However, when the distance between the electrodes was 50 μm, the electrolytic current value was about 5 times as large as that in the case of using the normal platinum electrodes (see FIG. 12B).

In the above example, platinum was used as the conductive material to which the organic compound was bonded. However, the conductive material is not limited to platinum. For example, metal such as gold, silver, or copper may be used as the conductive material. Alternatively, the conductive material may comprise a glass substrate having an Au film, or GaAs (gallium arsenide), CdS (cadmium sulfide), In₂O₃ (indium oxide (III)), carbon (graphite), or the like. According to another experiment, it has been confirmed that current-voltage properties similar to the above could be achieved in the case of using a glass substrate having an Au film. Further, an organic conductive material such as a polyaniline based material or carbon nanotubes may be used as the conductive material. Specifically, an organic compound having an ion exchange group may be bonded directly to an organic conductive material.

Oxidation or elution caused by electrolytic reactions may be problematic in the electrodes 86 of the electrode members 82. Therefore, it is desirable to use carbon, a noble metal which is relatively inert, conductive oxide, or conductive ceramics as a material for the electrode 86 rather than the metal and metallic compounds that are widely used for electrodes. An electrode using noble metal may be produced as follows. For example, titanium is used as a base material for an electrode, and platinum or iridium is attached to a surface of the base material by plating or coating. Then, the material is sintered at a high temperature for stabilization and maintenance of the strength. Ceramics products are generally obtained by heat treatment of an inorganic material. Various materials, such as oxides, carbides, and nitrides of nonmetal and metal, have been employed as a material for ceramics to produce ceramics products having various properties. Such ceramics products include conductive ceramics.

If an electrode is oxidized, then the electric resistance of the electrode is increased, so that a voltage to be applied should be increased. However, when a surface of an electrode is protected by a material that is unlikely to be oxidized, such as platinum, or a conductive oxide such as iridium oxide, it is possible to prevent the conductivity of the electrode from being lowered due to oxidization of the material of the electrode.

In the above example, thiol was used as the organic compound to be bonded to the conductive material. However, the organic compound is not limited to thiol. For example, disulfide or an organic conductive material such as a polyaniline based material or carbon nanotubes may be used as the organic compound. Further, the ion exchange group is not limited to a sulfonic acid group as described above. For example, a carboxyl group, a quaternary ammonium group, or an amino group may be used as the ion exchange group. According to an experiment, it has been confirmed that effects similar to those described above could be achieved when a carboxyl group was used as an ion exchange group of thiol.

When the ion exchange material described above is employed in the electrode members 82, the electrode members 82 do not cause problems such that fibers are removed from the ion exchanger during the electrolytic process. Therefore, it is possible to achieve stable processing performance. With an electrolytic processing apparatus according to the present invention, an ion exchange material having an ion exchange function can be bonded directly to an electrode. Therefore, it is possible to reduce the distance between the electrode and the workpiece and hence the distance between the anode and the cathode. Thus, the electrolytic processing apparatus according to the present invention can flexibly cope with small electrodes and various shapes of electrodes. Furthermore, because ion exchange materials can be bonded separately to a cathode and an anode, a leakage current can be prevented from being produced between the cathode and the anode.

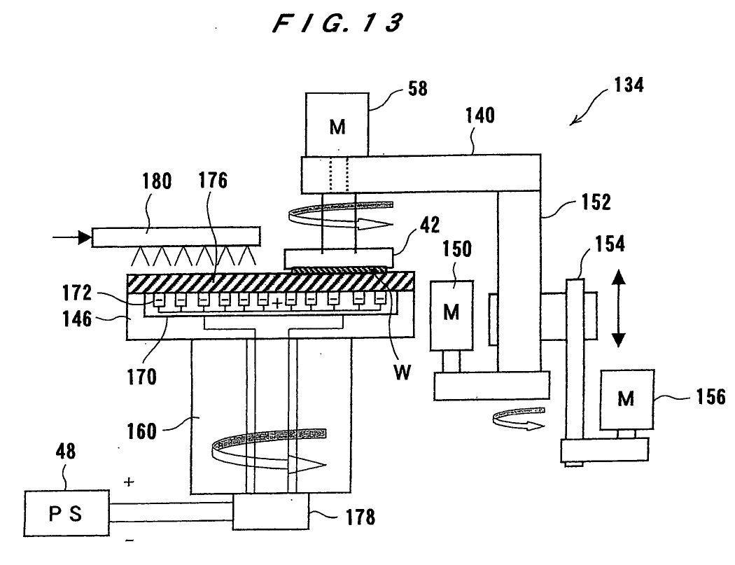

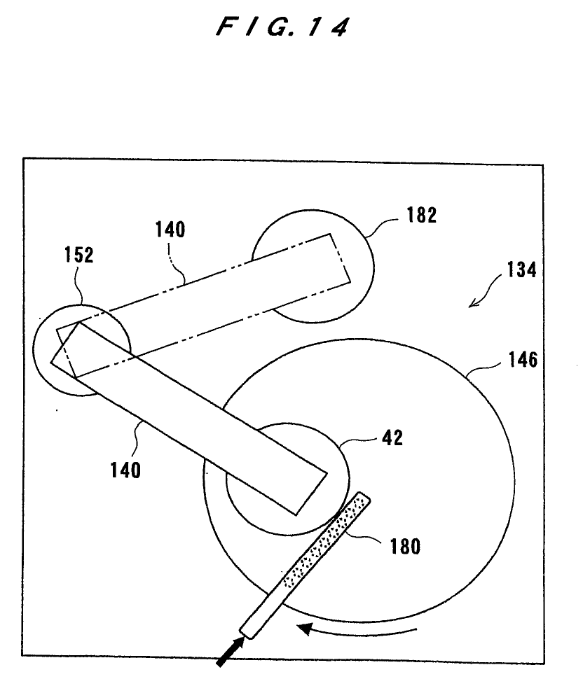

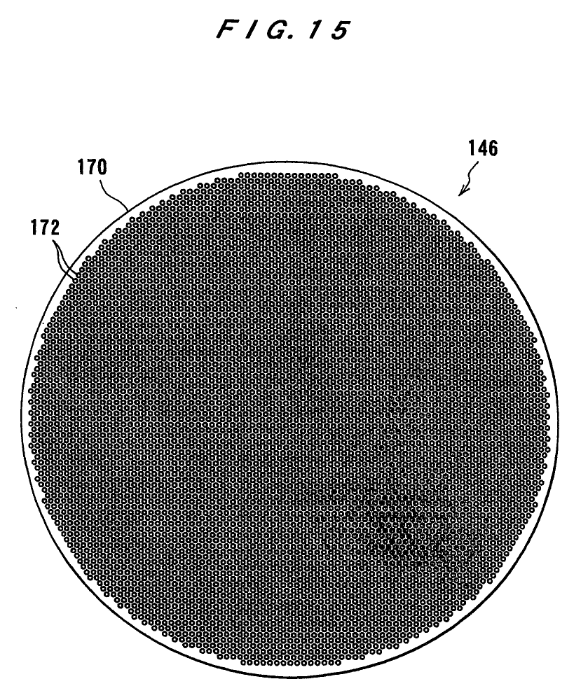

FIG. 13 is a vertical cross-sectional view schematically showing an electrolytic processing apparatus 134 according to a second embodiment of the present invention, and FIG. 14 is a plan view of FIG. 13. A substrate processing apparatus in the second embodiment has the same arrangement as that in the first embodiment, except for the electrolytic processing apparatus 134. Like or corresponding components in the second embodiment are designated by the same reference numerals as those shown in the first embodiment, and will not be described repetitively.

As shown in FIG. 13, the electrolytic processing apparatus 134 has an arm 140, a substrate holder 42 supported at a free end of the arm 140 for attracting and holding a substrate W in a state in which the substrate W faces downward (face-down), a circular electrode unit 146 positioned beneath the substrate holder 42, and a power supply 48 connected to the electrode unit 146. The arm 140 is vertically movable and can be pivoted horizontally.

The arm 140 is connected to an upper end of a pivot shaft 152, which is coupled to a pivotal movement motor 150. When the pivotal movement motor 150 is actuated, the arm 140 is horizontally pivoted about the pivot shaft 152. The pivot shaft 152 is connected to a vertically extending ball screw 154, which is coupled to a vertical movement motor 156. When the vertical movement motor 156 is actuated, the pivot shaft 152 is vertically moved via the ball screw 154 together with the arm 140.

The substrate holder 42 is coupled to a rotation motor 58 provided on an upper surface of the free end of the arm 140. The rotation motor 58 serves as a first driving mechanism to move the substrate W held by the substrate holder 42 and the electrode unit 146 relative to each other. When the rotation motor 58 is actuated, the substrate holder 42 is rotated. Since the arm 140 is vertically movable and horizontally swingable as described above, the substrate holder 42 can be vertically moved and horizontally pivoted together with the arm 140.

As shown in FIG. 13, the electrolytic processing apparatus 134 has a hollow motor 160 disposed below the electrode unit 146. The hollow motor 160 serves as a second driving mechanism to move the substrate W held by the substrate holder 42 and the electrode unit 146 relative to each other. The electrode unit 146 is coupled directly to the hollow motor 160. When the hollow motor 160 is actuated, the electrode unit 146 is rotated.

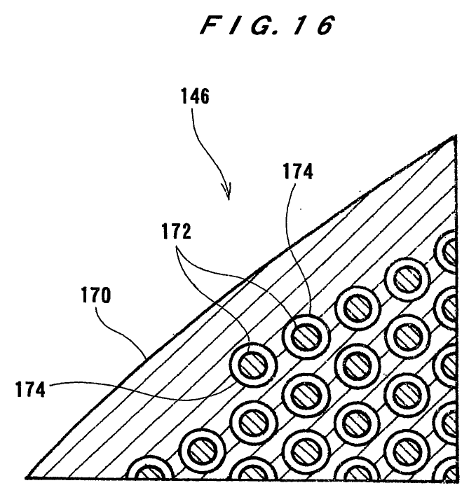

FIG. 15 is a plan view showing the electrode unit 146, and FIG. 16 is an enlarged view of FIG. 15. As shown in FIGS. 15 and 16, the electrode unit 146 has a circular feeding electrode 170 and a number of processing electrodes 172 arranged over substantially the entire surface of the feeding electrode 170. Each of the processing electrodes 172 is separated from the feeding electrode 170 by an insulating material 174. As with the first embodiment, an organic compound having an ion exchange group is chemically bonded to upper surfaces of the feeding electrode 170 and the processing electrodes 172 to form ion exchange materials 176 (see FIG. 13). For purposes of illustration, the electrode unit 146 is covered with ion exchange material 176 in FIG. 13. In fact, ion exchange materials are formed separately on the upper surface of the feeding electrode 170 and the upper surfaces of the processing electrodes 172. Each of the processing electrodes 172 has the same shape. The processing electrodes 172 are arranged within substantially the entire surface of the feeding electrode 170 so that the processing electrodes 172 are positioned at a substantially uniform frequency with respect to the surface of the substrate W when the substrate W and the electrode unit 146 are moved relative to each other. In the present embodiment, the feeding electrode 170 is disposed on the same side as the processing electrodes 172 with respect to the substrate W.

In the present embodiment, the feeding electrode 170 is connected to an anode of the power supply 48 via a slip ring 178 (see FIG. 13), and the processing electrodes 172 are connected to a cathode of the power supply 48 via the slip ring 178. For example, when copper is to be processed, an electrolytic effect is developed on the cathode. Accordingly, an electrode connected to the cathode forms a processing electrode, and an electrode connected to the anode forms a feeding electrode. Depending upon the material to be processed, the feeding electrode 170 may be connected to the cathode, and the processing electrodes 172 may be connected to the anode. For example, when the material to be processed is aluminum, silicon, or the like, an electrolytic effect is developed on the anode. Accordingly, an electrode connected to the anode forms a processing electrode, and an electrode connected to the cathode forms a feeding electrode.

As shown in FIG. 13, the electrolytic processing apparatus 134 has a pure water ejection nozzle 180 extending along a radial direction of the electrode unit 146. The pure water ejection nozzle 180 has a plurality of ejection slots for supplying pure water or ultrapure water onto the electrode unit 146. Thus, the pure water ejection nozzle 180 serves as a fluid supply unit for supplying a fluid (pure water or ultrapure water) between the substrate W and the electrode unit 146. Pure water refers to water having an electric conductivity of 10 μS/cm or less, and ultrapure water refers to water having an electric conductivity of 0.1 μS/cm or less. The use of pure water or ultrapure water, which contains substantially no electrolyte, can prevent undesired impurities such as an electrolyte from adhering to and remaining on the surface of the substrate W when the electrolytic process is performed. Further, copper ions or the like dissolved by the electrolytic process are immediately captured by the ion exchange materials 176 through an ion exchange reaction. Therefore, the dissolved copper ions or the like can be prevented from re-precipitating on other portions of the substrate W or from being oxidized to become fine particles which contaminate the surface of the substrate W.

As with the first embodiment, instead of pure water or ultrapure water, it is possible to use a liquid having an electric conductivity of 500 μS/cm or less, or any electrolytic solution. For example, an electrolytic solution prepared by adding an electrolyte to pure water or ultrapure water may be used instead of pure water or ultrapure water. Further, instead of pure water or ultrapure water, it is also possible to use a liquid prepared by adding a surfactant or the like to pure water or ultrapure water so as to have an electric conductivity of 500 μS/cm or less, preferably 50 μS/cm or less, more preferably 0.1 μS/cm or less (resistivity of 10 MΩ·cm or more).

Next, operation (electrolytic processing) with the substrate processing apparatus in the present embodiment will be described with reference to FIG. 5. First, a cassette accommodating substrates W is placed on one of the loading/unloading units 30. For example, as shown in FIG. 1B, the substrate W to be processed has a copper film 6 formed as a conductive film on a surface thereof. One of the substrates W is picked up from the cassette by the transfer robot 36. The transfer robot 36 transfers the substrate W to the reversing machine 32, as needed. By the reversing machine 32, the substrate W is turned upside down so that a surface of the substrate W having a conductive film (copper film 6) faces downward. The transfer robot 36 receives the reversed substrate W, and transfers it to the electrolytic processing apparatus 134. The transfer robot 36 places the substrate W on a pusher 182 (see FIG. 14) in the electrolytic processing apparatus 134.

The substrate W on the pusher 182 is then attracted and held by the substrate holder 42 of the electrolytic processing apparatus 134. The substrate holder 42 holding the substrate W is moved to a processing position, which is located right above the electrode unit 146, by pivoting the arm 140. The substrate holder 42 is then lowered by the actuation of the vertical movement motor 156 so that the substrate W held by the substrate holder 42 is brought into contact with or close to the surfaces of the ion exchange materials 176 in the electrode unit 146. Then, the rotational motor 58 is actuated to rotate the substrate holder 42 and the substrate W, and the hollow motor 160 is actuated to rotate the electrode unit 146. Thus, the substrate W and the electrode unit 146 are moved relative to each other, i.e., make eccentric rotational movements. At that time, pure water or ultrapure water is ejected between the substrate W and the electrode unit 146 from the ejection slots of the pure water ejection nozzle 180. Then, a predetermined voltage is applied between the processing electrodes 172 and the feeding electrode 170 by the power supply 48 to produce hydrogen ions and hydroxide ions by the ion exchange materials 176. Thus, the conductive film (copper film 6), which is formed on the surface of the substrate W, is subjected to electrolytic processing through the action of the hydrogen ions or the hydroxide ions on the processing electrodes (e.g., cathodes).

When a large number of electrodes are provided as in the present embodiment, even if the electrodes have the same shape, there may be a slight difference in contact area, in height between the respective electrodes, or in thickness between ion exchangers mounted on the respective electrodes. Further, the ion exchangers may be mounted unevenly on the respective electrodes. Accordingly, the processing amount per unit time differs in practice between the respective electrodes. In the present embodiment, when the electrode unit 146 and the substrate W are moved relative to each other during the electrolytic process, a plurality of processing electrodes 172, which have different processing rates per unit time, pass the same point on the surface of the substrate W. Specifically, the processing electrodes 172 and the substrate W are moved relative to each other so that the largest possible number of processing electrodes 172, which have different processing rates per unit time, can pass the same point on the surface of the substrate W. Therefore, even if the processing rate varies between the respective processing electrodes 172, the variation of processing rates can be averaged to equalize the processing rate over the entire surface of the substrate W to within a level of nanometers per minute.

After completion of the electrolytic process, the power supply 48 is disconnected, and the rotations of the electrode unit 146 and the substrate holder 42 are stopped. Thereafter, the substrate holder 42 is lifted and moved by the arm 40 to deliver the substrate W to the transfer robot 36. The transfer robot 36 receives the substrate W from the substrate holder 42 and transfers it to the reversing machine 32, as needed. By the reversing machine 32, the substrate W is turned upside down. Then, the transfer robot 36 returns the substrate W to the cassette on the loading/unloading unit 30.

In the present embodiment, both of the electrode unit 146 and the substrate W are rotated to make eccentric rotational movements. However, any relative movement may be employed between the processing electrodes and a workpiece as long as it allows a plurality of processing electrodes to pass the same point on a surface of the workpiece. Such a relative movement includes a rotational movement, a reciprocating movement, an eccentric rotational movement, and a scroll movement, and any combination of these movements. The relative movement may be a movement along the surface of the substrate W.

The processing electrodes and the feeding electrode in the present embodiment may be replaced with each other. Specifically, the electrode unit may have a circular processing electrode and a number of feeding electrodes arranged over substantially the entire surface of the processing electrode. In this case, the electrolytic processing apparatus employs a single processing electrode. Even though a single processing electrode is used, a processing amount per unit time may vary at some points on the processing electrode. However, with the above arrangement, when the electrode unit and the substrate W are moved relative to each other during the electrolytic process, a plurality of points on the processing electrode, which have different processing rates per unit time, pass the same point on the surface of the substrate W. Specifically, the processing electrode and the substrate W are moved relative to each other so that the largest possible number of points on the processing electrode, which have different processing rates per unit time, can pass the same point on the surface of the substrate W. Therefore, even if the processing rate varies between the respective points on the processing electrode, the variation of processing rates can be averaged to equalize the processing rate over the entire surface of the substrate W to within a level of nanometers per minute.

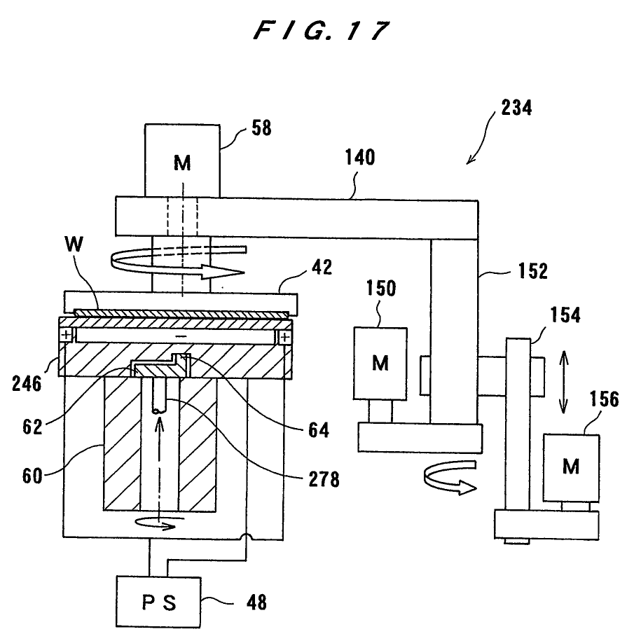

FIG. 17 is a vertical cross-sectional view schematically showing an electrolytic processing apparatus 234 according to a third embodiment of the present invention. A substrate processing apparatus in the third embodiment has the same arrangement as that in the first embodiment, except for the electrolytic processing apparatus 234. Like or corresponding components in the second embodiment are designated by the same reference numerals as those shown in the first or second embodiment, and will not be described repetitively.

As shown in FIG. 17, the electrolytic processing apparatus 234 has an arm 140, a substrate holder 42 supported at a free end of the arm 140 for attracting and holding a substrate W in a state in which the substrate W faces downward (face-down), a circular electrode unit 246 positioned beneath the substrate holder 42, and a power supply 48 connected to the electrode unit 246. The arm 140 is vertically movable and can be pivoted horizontally.

The arm 140 is connected to an upper end of a pivot shaft 152, which is coupled to a pivotal movement motor 150. When the pivotal movement motor 150 is actuated, the arm 140 is horizontally pivoted about the pivot shaft 152. The pivot shaft 152 is connected to a vertically extending ball screw 154, which is coupled to a vertical movement motor 156. When the vertical movement motor 156 is actuated, the pivot shaft 152 is vertically moved via the ball screw 154 together with the arm 140.

The substrate holder 42 is coupled to a rotation motor 58 provided on an upper surface of the free end of the arm 140. The rotation motor 58 serves as a first driving mechanism to move the substrate W held by the substrate holder 42 and the electrode unit 246 relative to each other. When the rotation motor 58 is actuated, the substrate holder 42 is rotated. Since the arm 140 is vertically movable and horizontally swingable as described above, the substrate holder 42 can be vertically moved and horizontally pivoted together with the arm 140.

As shown in FIG. 17, the electrolytic processing apparatus 234 has a hollow motor 60 disposed below the electrode unit 246. The hollow motor 60 serves as a second driving mechanism to move the substrate W held by the substrate holder 42 and the electrode unit 246 relative to each other. The hollow motor 60 has a main shaft 62, and the main shaft 62 has a driving end 64 provided on an upper end of the main shaft 62 at an eccentric position to the center of the main shaft 62. The electrode unit 246 is rotatably coupled to the driving end 64 of the hollow motor 60 at the center of the electrode unit 246 via a bearing (not shown). Three or more rotation-prevention mechanisms are provided between the electrode unit 246 and the hollow motor 60 along a circumferential direction. These rotation-prevention mechanisms have been described in the first embodiment and will not be described repetitively.

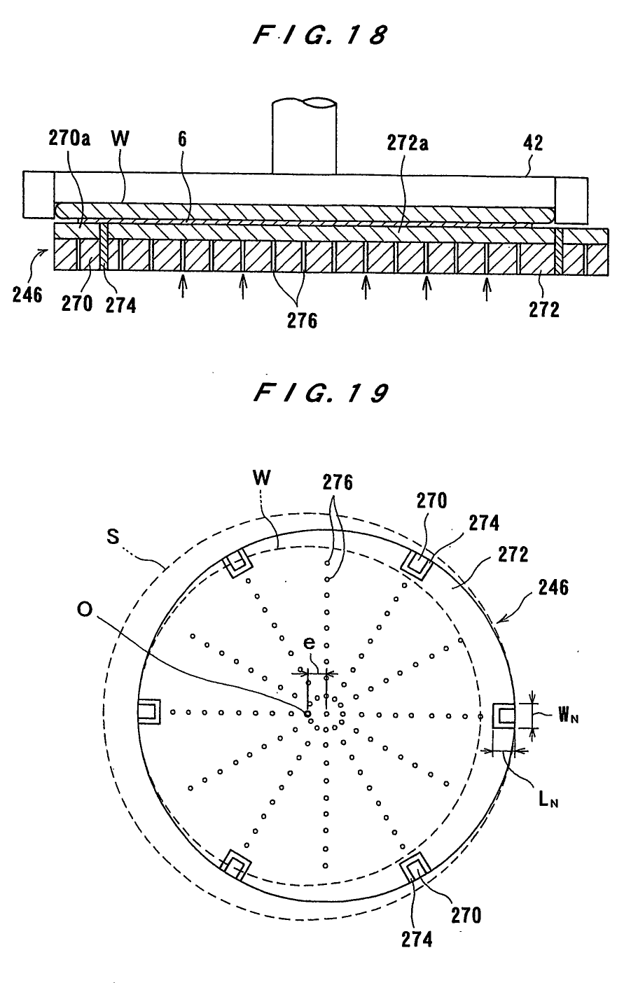

FIG. 18 is a vertical cross-sectional view schematically showing the substrate holder 42 and the electrode unit 246, and FIG. 19 is a plan view showing the relationship between the substrate W and the electrode unit 246. In FIG. 19, the substrate W is shown with a broken line. As shown in FIGS. 18 and 19, the electrode unit 246 has a plurality of feeding electrodes 270, a substantially circular processing electrode 272, which has a diameter larger than that of the substrate W, and insulating materials 274 for separating the processing electrode 272 and the feeding electrodes 270. The feeding electrodes 270 are disposed at a peripheral portion of the processing electrode 272. As shown in FIG. 18, an organic compound having an ion exchange group is chemically bonded to upper surfaces of the feeding electrodes 270 to form ion exchange materials 270a, and an organic compound having an ion exchange group is chemically bonded to an upper surface of the processing electrode 272 to form an ion exchange material 272a. Specifically, in the present embodiment, the processing electrode 272 and the feeding electrodes 270 are spaced on the same side of the substrate W, and an organic compound having an ion exchange group is bonded separately to the processing electrode 272 and the feeding electrodes 270. For purposes of illustration, the ion exchange materials 270a and 272a are not shown in FIG. 19.

In the present embodiment, it is difficult to supply pure water or ultrapure water to the upper surface of the electrode unit 246 from above the electrode unit 246 during the electrolytic process due to the size relationship between the electrode unit 246 and the substrate holder 42. Accordingly, as shown in FIGS. 18 and 19, the electrode unit 246, particularly the processing electrode 272, has a plurality of liquid supply holes 276. The liquid supply holes 276 serve as a fluid supply unit for supplying a fluid (pure water or ultrapure water) to the upper surface of the processing electrode 272. In the present embodiment, the fluid supply holes 276 are disposed radially with respect to the center of the processing electrode 272. The fluid supply holes 276 are connected to a pure water supply pipe 278 (see FIG. 17) extending through the hollow portion of the hollow motor 60, so that pure water or ultrapure water is supplied through the pure water supply pipe 278 from the fluid supply holes 276 to the upper surface of the electrode unit 246.

In the present embodiment, the processing electrode 272 is connected to a cathode of the power supply 48, and the feeding electrodes 270 are connected to an anode of the power supply 48. Depending upon a material to be processed, the feeding electrodes 270 may be connected to the cathode, and the processing electrode 272 may be connected to the anode. For example, when a material to be processed is copper, molybdenum, iron, or the like, an electrolytic effect is developed on the cathode. Accordingly, an electrode connected to the cathode forms a processing electrode, and an electrode connected to the anode forms a feeding electrode. For example, when a material to be processed is aluminum, silicon, or the like, an electrolytic effect is developed on the anode. Accordingly, an electrode connected to the anode forms a processing electrode, and an electrode connected to the cathode forms a feeding electrode.

During the electrolytic process, the rotation motor 58 is actuated to rotate the substrate W, and the hollow motor 60 is actuated so that the electrode unit 246 makes a scroll movement about a scrolling center “O” (see FIG. 19). Thus, the substrate W held by the substrate holder 42 and the processing electrode 272 are moved relative to each other within a scrolling region S to process the entire surface of the substrate W (copper film 6). The electrolytic processing apparatus 234 in the present embodiment is designed such that the center of movement of the processing electrode 272 (the center “O” of the scroll movement according to the present embodiment) is continuously located within an inner range of the substrate W during the relative movement. Specifically, the processing electrode 272 has a diameter larger than that of the substrate W, and the center of movement of the processing electrode 272 is continuously located within the inner range of the substrate W. As a result, the frequency that the processing electrode 272 is positioned at any given point on the substrate W can become as uniform as possible over the surface of the substrate W. With this arrangement, it is possible to minimize the size of the electrode unit 246, and hence the whole apparatus can be made considerably compact and lightweight. It is desirable that the diameter of the processing electrode 272 be larger than the sum of the distance of the relative movement between the substrate W and the processing electrode 272 (a scrolling radius “e” according to the present embodiment) and the diameter of the substrate W and smaller than twice the diameter of the substrate W.

Since the substrate W cannot be processed within the range of the feeding electrodes 270, the processing rate at peripheral portions of the electrode unit 246, in which the feeding electrodes 270 are disposed, is lower than that in other areas. Therefore, an area (region) occupied by the feeding electrodes 270 should preferably be smaller in order to reduce the influence from the feeding electrodes 270 on the processing rate. From this viewpoint, in the present embodiment, the feeding electrodes 270 having a small area are disposed at a plurality of peripheral portions of the processing electrode 272, and at least one of the feeding electrodes 270 is brought into contact with or close to the substrate W during the relative movement. Accordingly, it is possible to reduce an area that is not being processed, as compared to a case where a ring-shaped feeding electrode is disposed at a peripheral portion of the processing electrode 272. Thus, a peripheral portion of the substrate W is prevented from remaining unprocessed.

Next, operation (electrolytic processing) with the substrate processing apparatus in the present embodiment will be described with reference to FIG. 5. First, a cassette accommodating substrates W is placed on one of the loading/unloading units 30. For example, as shown in FIG. 1B, the substrate W to be processed has a copper film 6 formed as a conductive film on a surface thereof. One of the substrates W is picked up from the cassette by the transfer robot 36. The transfer robot 36 transfers the substrate W to the reversing machine 32, as needed. By the reversing machine 32, the substrate W is turned upside down so that a surface of the substrate W having a conductive film (copper film 6) faces downward.

The transfer robot 36 receives the reversed substrate W, and transfers it to the electrolytic processing apparatus 234. The substrate W is then attracted and held by the substrate holder 42 of the electrolytic processing apparatus 234. The substrate holder 42 holding the substrate W is moved to a processing position, which is located right above the electrode unit 246, by pivoting the arm 140. The substrate holder 42 is then lowered by the actuation of the vertical movement motor 156 so that the substrate W held by the substrate holder 42 is brought into contact with or close to the surfaces of the ion exchange materials 270a and 272a in the electrode unit 246. Then, the rotational motor 58 is actuated to rotate the substrate holder 42 and the substrate W, and the hollow motor 60 is actuated so that the electrode unit 246 makes a scroll movement about the scrolling center “O”. Thus, the substrate W and the electrode unit 246 are moved relative to each other. At that time, pure water or ultrapure water is ejected between the substrate W and the ion exchange materials 270a, 272a from the fluid supply holes 276 in the processing electrode 272.

Then, a predetermined voltage is applied between the processing electrode 272 and the feeding electrodes 270 by the power supply 48 to produce hydrogen ions and hydroxide ions by the ion exchange materials 270a, 272a. Thus, the conductive film (copper film 6), which is formed on the surface of the substrate W, is subjected to electrolytic processing through the action of the hydrogen ions or the hydroxide ions on the processing electrodes (e.g., cathodes).

At that time, the substrate W is processed at a portion facing the processing electrode 272. Since the substrate W and the processing electrode 272 are moved relative to each other during the electrolytic process as described above, the entire surface of the substrate W can be processed. The diameter of the processing electrode 272 is larger than that of the substrate W, and the center of movement of the processing electrode 272 is continuously located within the inner range of the substrate W. As a result, the frequency that the processing electrode 272 is positioned at any given point on the substrate W can become as uniform as possible over the surface of the substrate W. With this arrangement, it is possible to minimize the size of the electrode unit 246, and hence the whole apparatus can be made considerably compact and lightweight.

After completion of the electrolytic process, the power supply 48 is disconnected, and the rotation of the substrate holder 42 and the scroll movement of the electrode unit 246 are stopped. Thereafter, the substrate holder 42 is lifted and moved by the arm 140 to deliver the substrate W to the transfer robot 36. The transfer robot 36 receives the substrate W from the substrate holder 42 and transfers it to the reversing machine 32, as needed. By the reversing machine 32, the substrate W is turned upside down. Then, the transfer robot 36 returns the substrate W to the cassette on the loading/unloading unit 30.

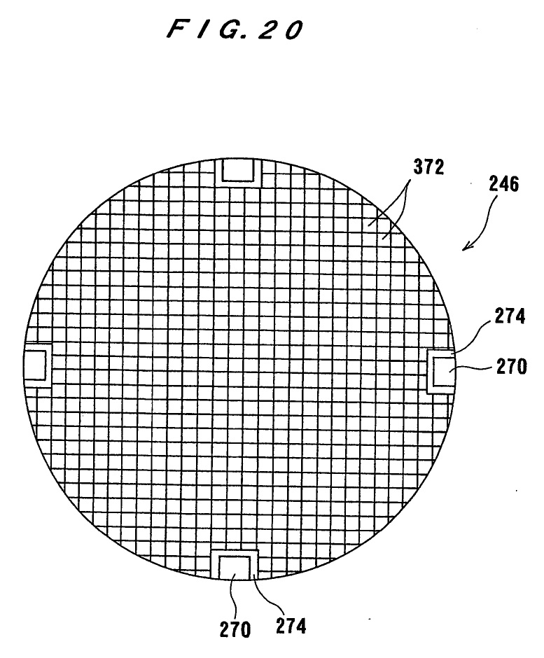

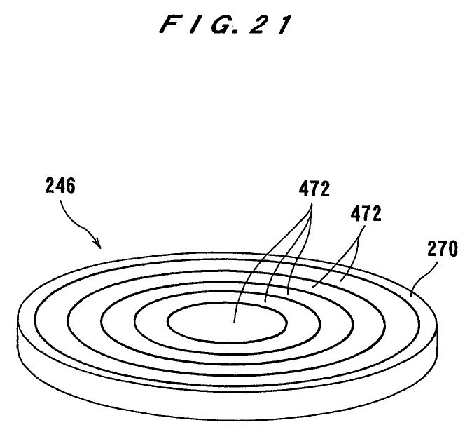

In the above embodiment, the processing electrode 272 in the electrode unit 246 is formed as a single member. However, the electrode unit 246 may have other types of processing electrodes. For example, as shown in FIG. 20, the electrode unit 246 may have a plurality of processing electrodes 372 divided in a lattice form. Alternatively, as shown in FIG. 21, the electrode unit 246 may have a plurality of processing electrodes 472 divided annularly. In the example shown in FIG. 21, a ring-like feeding electrode 270 surrounds the divided processing electrodes 472. In these cases, the divided processing electrodes may either be electrically integrated or electrically separated by insulating materials.

As described above, with the electrode unit 246 as shown in FIG. 19, since the substrate W cannot be processed within the range of the feeding electrodes 270, the processing rate at the peripheral portions of the electrode unit 246, in which the feeding electrodes 270 are disposed, is lower than that in other areas. The processing rate of the peripheral portions of the substrate W can be controlled by adjusting a notch width w_{N} and a notch length L_{N} (see FIG. 19) at the peripheral portions of the processing electrode 272.

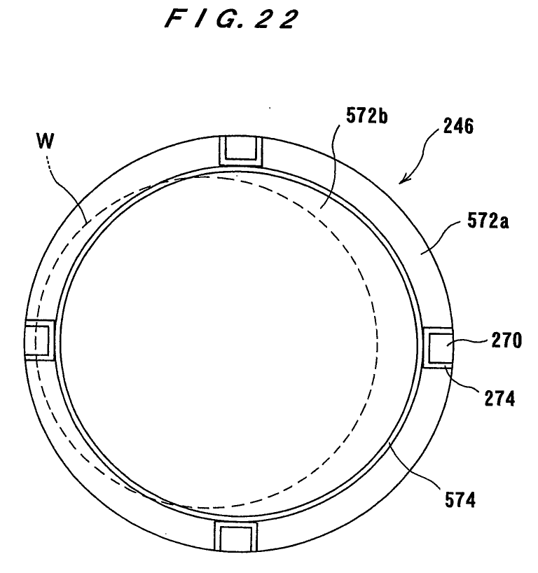

FIG. 22 shows a modification of the electrode unit 246 shown in FIG. 19. The electrode unit 246 shown in FIG. 22 has an outer processing electrode 572a and an inner processing electrode 572b, which are separated by insulating materials 574. The outer processing electrode 572a is positioned at a portion at which the feeding electrodes 270 have an influence on the processing rate, i.e., at a peripheral portion at which the feeding electrodes 270 are disposed. The inner processing electrode 572b is positioned at a portion at which the feeding electrodes 270 have no influence on the processing rate, i.e., at an inner side of the outer processing electrode 572a. With such an electrode unit 246, a uniform processing rate can be achieved over the entire surface of the processing electrode Specifically, in view of the influence of the presence of the feeding electrodes 270, a voltage or an electric current applied by the power supply 48 to each of the processing electrodes 572a and 572b is adjusted so as to make the processing rate at the outer processing electrode 572a higher than the processing rate at the inner processing electrode 572b. Thus, a uniform processing rate can be achieved over the entire surfaces of the processing electrodes. Desired voltages may be applied to each of the outer processing electrode 572a and the inner processing electrode 572b, respectively. According to the present invention, ion exchange materials can be attached directly to electrodes, which have various sizes and shapes. Therefore, it is not necessary to cut ion exchange fibers or ion exchange membranes according to the shapes of the electrodes.

In the above embodiment, the electrode unit 246 makes a scroll movement, and the substrate W is rotated. However, any relative movement between the electrode unit 246 and the substrate W can be employed as long as it can move the processing electrode 272 and the substrate W relative to each other. For example, both of the electrode unit 246 and the substrate W may be rotated. In this case, the center of rotation corresponds to the center of movement of the processing electrode.

In the above embodiments, the substrate W is attracted and held in a state in which the substrate W faces downward (face-down). However, the substrate W may be held in a state in which the substrate W faces upward (face-up).

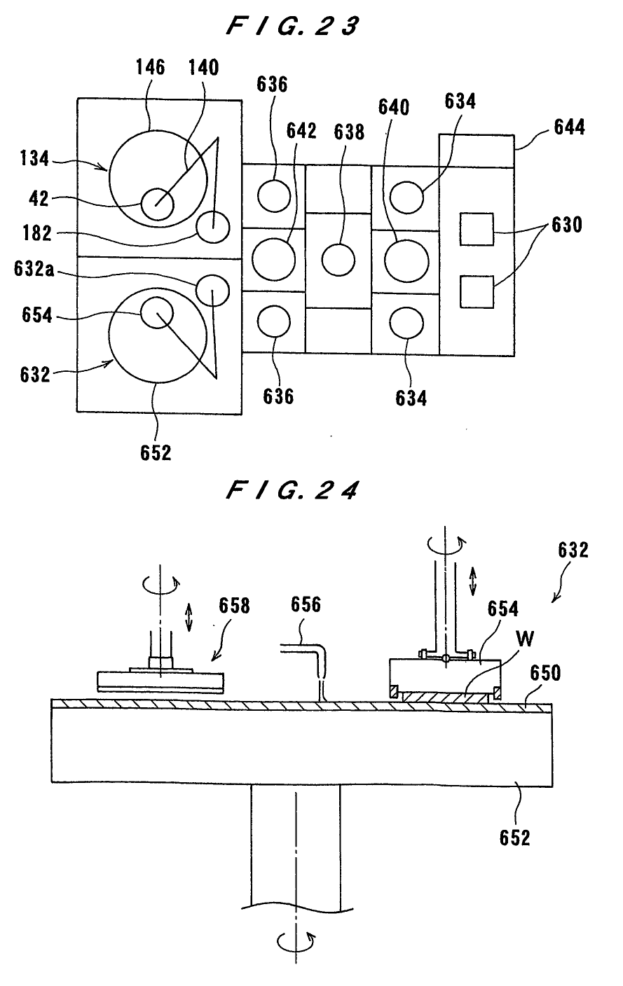

FIG. 23 is a plan view showing a substrate processing apparatus according to a fourth embodiment of the present invention. The substrate processing apparatus has a pair of loading/unloading units 630, the electrolytic processing apparatus 134 described in the second embodiment, a CMP apparatus 632, two primary cleaning devices 634, and two secondary cleaning devices 636. The loading/unloading units 30 serve as a loading and unloading section for loading and unloading a cassette accommodating substrates W. The electrolytic processing apparatus 134 has a pusher 182 for receiving and delivering a substrate. The CMP apparatus 632 has a pusher 632a for receiving and delivering a substrate.

The substrate processing apparatus has a temporary placement stage 638 disposed between the primary cleaning devices 634 and the secondary cleaning devices 636, a first transfer robot 640, a second transfer robot 642, and a monitoring unit 644 disposed adjacent to the loading/unloading units 30. The temporary placement stage 638 has a function of reversing a substrate. The first transfer robot 640 is surrounded by the loading/unloading units 630, the primary cleaning devices 634, and the temporary placement stage 638 and serves as a transfer device for receiving and delivering a substrate W between the loading/unloading units 630, the primary cleaning devices 634, and the temporary placement stage 638. The second transfer robot 642 is surrounded by the temporary placement stage 638, the secondary cleaning devices 636, the pusher 182, and the pusher 632a and serves as a transfer device for receiving and delivering a substrate W between the temporary placement stage 638, the secondary cleaning devices 636, the pusher 182, and the pusher 632a. The monitoring unit 644 monitors a voltage applied between the processing electrode and the feeding electrode or a current flowing therebetween when the electrolytic processing apparatus 134 performs an electrolytic process.

FIG. 24 is a schematic view showing an example of the CMP apparatus 632. As shown in FIG. 24, the CMP apparatus 632 has a polishing table 652 having a polishing pad (polishing cloth) 650 attached on an upper surface thereof, and a top ring 654 for holding and pressing a substrate W against an upper surface of the polishing pad 650 on the polishing table 652. The polishing pad 650 has an upper surface serving as a polishing surface which is brought into sliding contact with the substrate W to be polished. The polishing table 652 and the top ring 654 are independently rotated, and a polishing liquid is supplied onto the polishing pad 650 from a polishing liquid supply nozzle 656 disposed above the polishing table 652. The substrate W is pressed against the polishing pad 650 on the polishing table 652 under a predetermined pressure by the top ring 654 to polish a surface of the substrate W. For example, a suspension of fine abrasive particles of silica or the like in an alkali solution is used as the polishing liquid supplied from the polishing liquid supply nozzle 656. Thus, the substrate W is polished to a flat mirror finish by the combined effect of a chemical polishing effect attained by the alkali and a mechanical polishing effect attained by the polishing particles.

When the substrate W is continuously polished with such a polishing apparatus, a polishing capability of the polishing surface of the polishing pad 650 is lowered. In order to recover the polishing capability of the polishing surface, a dresser 658 is provided in a CMP apparatus 632. The polishing pad 650 is dressed by the dresser 658 at the time, for example, of replacement of a substrate W. Specifically, while a dressing element attached to a lower surface of the dresser 658 is pressed against the polishing pad 650 on the polishing table 652, the polishing table 652 and the dresser 658 are independently rotated to remove polishing particles and polishing wastes attached to the polishing surface and to flatten and dress the entire polishing surface. Thus, the polishing surface is regenerated by the dresser 658.

A cassette accommodating substrates W is placed on one of the loading/unloading units 630. One of the substrates W is picked up from the cassette by the first transfer robot 640. The first transfer robot 640 transfers the substrate W to the temporary placement stage 638, where the substrate W is turned upside down as needed. The second transfer robot 642 receives the substrate W and transfers it to the pusher 182 of the electrolytic processing apparatus 134. The substrate W is then delivered between the pusher 182 and the substrate holder 42 of the electrolytic processing apparatus 134. In the electrolytic processing apparatus 134, a surface of the substrate W is subjected to electrolytic polishing to remove a conductive material (copper film 6), for example. Then, the substrate W is returned to the pusher 182. The second transfer robot 642 receives the substrate from the pusher 182 and transfers it to the pusher 632a of the CMP apparatus 632. The substrate W is then delivered from the pusher 632a to the top ring 654 of the CMP apparatus 632. In the CMP apparatus 632, the surface of the substrate W is subjected to chemical mechanical polishing to remove barrier metal (barrier layer 5), for example. Then, the substrate W is returned to the pusher 632a. The second transfer robot 642 receives the finished substrate from the pusher 632a and transfers it to one of the secondary cleaning devices 636 to perform rough cleaning. Then, the second transfer robot 642 transfers the substrate W to the temporary placement stage 638, where the substrate W is turned upside down as needed. The first transfer robot 640 receives the substrate W and transfers it to one of the primary cleaning devices 634. The substrate is cleaned and dried in the primary cleaning devices 634 and returned to the cassette on the loading/unloading unit 630 by the first transfer robot 640.

In the present embodiment, rough polishing is performed by the electrolytic process in the electrolytic processing apparatus 134, and finishing polishing is performed by chemical mechanical polishing in the CMP apparatus 632. However, rough polishing may be performed by chemical mechanical polishing in the CMP apparatus 632, and finishing polishing may be performed by the electrolytic process in the electrolytic processing apparatus 134. In this case, loads on the CMP process can be reduced. In the present embodiment, the electrolytic processing apparatus in the second embodiment is employed as the electrolytic processing apparatus. However, the electrolytic processing apparatus is not limited to the electrolytic processing apparatus in the second embodiment and can employ any of the electrolytic processing apparatuses in the above embodiments.

In the above embodiments, an organic compound having an ion exchange group is chemically bonded to a surface of an electrode to form an ion exchanger on the surface of the electrode. Specifically, gold, silver, platinum, copper, indium oxide, or the like is used as an electrode material (conductive material), and thiol, disulfide, or the like is used as an organic compound having an ion exchange group. Such an organic compound is chemically bonded to the electrode material to introduce the ion exchange group into the electrode material. Instead of using such an electrode, a surface of a conductive carbon material may be chemically modified by an ionic dissociation functional group. Specifically, a conductive carbon material is used as an electrode material, and an ionic dissociation functional group is effectively introduced directly into a surface of the carbon of the conductive carbon material by inorganic reactions. In such a case, there are no carbon chains due to an organic compound between the electrode material and the ionic dissociation functional group (or an ion exchange group). Therefore, the thickness of the chemical modification layer can be reduced, and the durability (or the resistance to removal) and the conductivity of the ionic dissociation functional group can be improved.

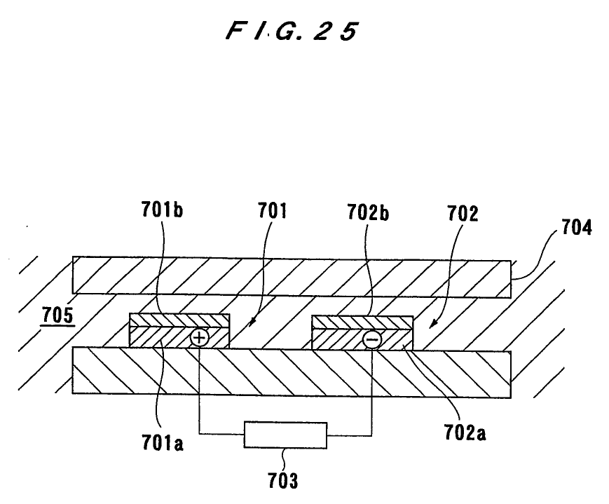

FIG. 25 is a schematic diagram showing an electrolytic processing apparatus using such an electrode. As shown in FIG. 25, the electrolytic processing apparatus has a pair of electrodes 701 and 702. The electrodes 701 and 702 have conductive carbon materials 701a and 702a connected to an anode and a cathode of a power supply 703, respectively. A surface of the conductive carbon material 701a is chemically modified by an ionic dissociation functional group 701b, and a surface of the conductive carbon material 702a is chemically modified by an ionic dissociation functional group 702b. A fluid 705 such as pure water or ultrapure water is supplied between the electrodes 701, 702 and a workpiece 704 (e.g., a copper film formed on a substrate). Then, the workpiece 704 is brought close to the ionic dissociation functional groups 701b, 702b in the electrodes 701, 702. A voltage is applied between the conductive carbon materials 701a and 702a in the electrodes 701, 702 by the power supply 703. Water molecules in the fluid 705 are dissociated into hydroxide ions and hydrogen ions by the ionic dissociation functional groups 701b, 702b. For example, the produced hydroxide ions are supplied to a surface of the workpiece 704. The concentration of the hydroxide ions is thus increased near the workpiece 704, and atoms in the workpiece 704 and the hydroxide ions are reacted with each other to perform removal of a surface layer of the workpiece 704.

Thus, it is possible to reduce the distance between the electrodes 701, 702 and the workpiece (substrate) 704 and hence the distance between the electrode 701 serving as an anode and the electrode 702 serving as a cathode. Therefore, the electrolytic processing apparatus can flexibly cope with small electrodes and various shapes of electrodes. Furthermore, because the conductive carbon material 701a serving as an anode and the conductive carbon material 702a serving as a cathode are separately bonded to (or chemically modified by) the ionic dissociation functional groups 701b, 702b, a leakage current can be prevented from being produced between the cathode and the anode, i.e., between the electrodes 701 and 702.

Such an electrode, which has a conductive carbon material and an ionic dissociation functional group chemically modifying a surface of the conductive carbon material, can be used in a substrate processing apparatus or an electrolytic processing apparatus of the above embodiments shown in FIGS. 5 through 11 and FIGS. 13 through 24, instead of an electrode in which an organic compound is chemically bonded to a surface of a conductive material.

The ionic dissociation functional group, which chemically modifies the surface of the conductive carbon material, comprises a basic group such as a quaternary ammonium group or a tertiary or lower amino group, or an acidic group such as a carboxyl group.

When the electrode is to be used to process a relatively large area of about 1 cm² or more, the conductive carbon material should preferably comprise a carbon material that has a flat and smooth surface and can be processed in shape with high accuracy, such as glassy carbon. When the electrode is to be used to perform fine processing at a level of 1 μm or less than 1 μm, fullerene or carbon nanotubes should preferably be used as the conductive carbon material. It is desirable that the conductive carbon material has meshes because such meshes can allow water to pass therethrough to decompose water efficiently.

Methods of chemically modifying a conductive carbon material with an ionic dissociation functional group such as an ion exchange group include immersing a conductive carbon material in a chemical liquid, electrical discharge processing a conductive carbon material in a gaseous phase, and anodizing a conductive carbon material in an electrolytic solution.

For example, as a method of immersing a conductive carbon material in a chemical liquid, a conductive carbon material is immersed in an oxidizing solution such as a nitric acid. With this method, a surface of the conductive carbon material can be readily chemically modified by an ionic dissociation functional group such as a carboxyl group.

For example, as a method of electrical discharge processing a conductive carbon material in a gaseous phase, plasma is formed in a gas containing oxygen by RF electrical discharge (13.25 MHz), and a conductive carbon material is exposed to the plasma. With this method, a surface of the conductive carbon material can be chemically modified by an ionic dissociation functional group such as a carboxyl group. Plasma may be formed in a nitrogen atmosphere by electrical discharge, and a conductive carbon material may be exposed to the plasma. In such a case, an ionic dissociation functional group having basicity can be introduced into the conductive carbon material. These methods can suitably be used to chemically modify a conductive carbon material by an ionic dissociation functional group. See S. S. Wong, A. T. Woolley, E. Joselevich, C. M. Leiber, Chem. Phys. Lett., 306 (1999) 219.

In a method of anodizing a conductive carbon material in an electrolytic solution, a conductive carbon material is usually used as an anode. Metal such as platinum (Pt), gold (Au), lead (Pb), and zinc (Zn), and any carbon material can be used as a cathode. See J. H. Wandass, J. A. Gardella, N. L. Weinberg, M. E. Bolster, L. Salvati, J. Electrochem. Soc., 134 (1987) 2734. The electrolytic solution may contain nitric acid, sulfuric acid, phosphoric acid, hydrochloric acid, hydrobromic acid, or salts having ions contained in these acids. Such salts include salts of alkali metal such as lithium, sodium, and potassium, salts of alkaline-earth metal such as magnesium, calcium, and barium, ammonium salt, sulfonium salt, phosphonium salt, and salts of Fe, Cu, and lanthanoide metal. Practically, a single electrolytic solution or a mixture of these kinds of electrolytic solutions is used. Although it is desirable that the electrolytic current density is in a range of from about 1 to about 100 mA/cm², the method is not limited to these conditions. With this method, a surface of a carbon material is chemically modified by a carboxyl group.

According to the method of electrical discharge processing a conductive carbon material in a gaseous phase, an electrode in which a carboxyl group was introduced into a conductive carbon material was produced as follows. Two rod-like electrodes, which were moistened with water, were spaced at about 3 cm. An alternating voltage of 100 V was applied between the electrodes. A carbon rod (conductive carbon material), which was moistened with water, was inserted into between electrodes. Arc discharge was caused in an atmosphere to treat a surface of the carbon rod by the arc discharge so as to introduce a carboxyl group into the surface of the carbon rod (conductive carbon material). The carbon rod was made of graphite having a diameter of 6 mm. Each end of the carbon rod was rounded. The water used was ultrapure water, which had a resistivity of 18.2 MΩ·cm.

The current-voltage properties were measured in an experimental device in which the carbon rod thus treated was used as an anode, and a platinum plate was used as a cathode. The experimental device had an acrylic container holding ultrapure water therein, which has a resistivity of 18.2MΩ·cm. The carbon rod and the platinum plate faced each other in the container. After the distance between the carbon rod and the platinum plate was adjusted by a micrometer, a voltage was applied between the carbon rod and the platinum plate while ultrapure water was supplied between the carbon rod and the platinum plate. At that time, a flowing current was measured. The distance between the carbon rod and the platinum plate was set to be 15 μm.

Further, the current-voltage properties were measured in a manner similar to the above for a comparative experiment in which a carbon rod before the surface treatment by the arc discharge was used as an anode, and a platinum plate was used as a cathode.

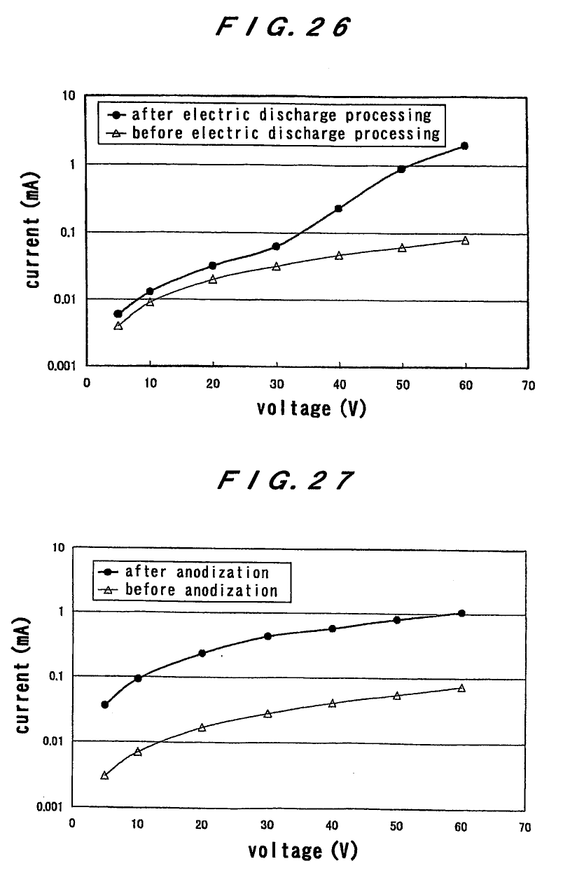

FIG. 26 shows results of the above experiments. It can be seen from FIG. 26 that the carbon rod into which a carboxyl group was introduced by the surface treatment with the arc discharge had increased current at 60 V by ten or more times as compared to the carbon rod into which the carboxyl group was not introduced.

According to the method of anodizing a conductive carbon material in an electrolytic solution, an electrode in which a carboxyl group was introduced into a conductive carbon material was produced as follows. A carbon rod (conductive carbon material) was used as an anode and anodized in an H₂SO₄ solution of 20 weight % at a current density of 12.5 MA/cm² for 30 minutes. A platinum plate (Pt) was used as a facing electrode. The carbon rod was made of graphite having a diameter of 6 mm. Each end of the carbon rod was rounded. The current-voltage properties of the anodized carbon rod were measured under conditions similar to the above example. The distance between the carbon rod and the platinum plate was set to be 15 μm.

Further, the current-voltage properties were measured in a manner similar to the above example for a comparative experiment in which a carbon rod before the surface treatment by anodization was used as an anode, and a platinum plate was used as a cathode.

FIG. 27 shows results of the above experiments. It can be seen from FIG. 27 that the carbon rod into which a carboxyl group was introduced by anodization had increased current by ten or more times as compared to the carbon rod into which the carboxyl group was not introduced.

The carbon rod into which a carboxyl group was introduced by anodization was used as a processing electrode to perform an electrolytic process of a copper film formed on a silicon substrate. The electrolytic process was conducted at a voltage of 60 V and a current of 1.07 mA for 10 seconds while the distance between electrodes was 25 μm. As a result of the electrolytic process, the maximum processed depth was 144 nm. At that time, the current efficiency was about 48%. The current efficiency refers to a ratio of the quantity of electricity used to process the copper film to the entire quantity of electricity passed. The current efficiency was calculated on the assumption that copper was eluted as bivalent ions or bivalent ionic compounds.

The carbon rod into which a carboxyl group was not introduced by anodization was used as a processing electrode to perform an electrolytic process of a copper film formed on a silicon substrate. The electrolytic process was conducted at a voltage of 60 V and a current of 0.043 mA for 60 seconds. As a result of the electrolytic process, the maximum processed depth was 12 nm. At that time, the current efficiency was about 3.3%.

Thus, it can be seen that the carbon rod into which a carboxyl group was introduced by anodization had increased current during the electrolytic process and increased current efficiency as compared to the carbon rod into which the carboxyl group was not introduced.

Instead of using an electrode in which a surface of a conductive carbon material is chemically modified by an ion dissociation functional group, a graphite intercalation compound containing alkali metal may be used as an electrode. It is generally desirable that high orientated pyrolytic graphite (HOPG) is used as graphite (carbon material) in the graphite intercalation compound. However, when sodium is intercalated as alkali metal between layers of the graphite, it is desirable that low orientated graphite is used as the graphite in the graphite intercalation compound. The graphite intercalation compound should preferably have meshes because such meshes can allow water to pass therethrough to decompose water efficiently.

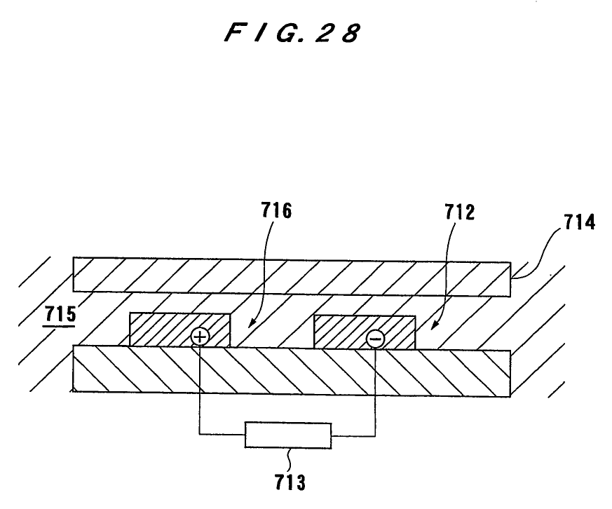

FIG. 28 is a schematic diagram showing an electrolytic processing apparatus using such an electrode. As shown in FIG. 28, the electrolytic processing apparatus has a pair of electrodes 711 and 712 connected to an anode and a cathode of a power supply 713. The electrodes 711 and 712 are made of a graphite intercalation compound containing alkali metal. A fluid 715 such as pure water or ultrapure water is supplied between the electrodes (graphite intercalation compounds) 711, 712 and a workpiece 714 (e.g., a copper film formed on a substrate). Then, the workpiece 714 is brought close to the electrodes 711, 712. A voltage is applied between the electrodes 711 and 712 by the power supply 713. Water molecules in the fluid 715 are dissociated into hydroxide ions and hydrogen ions by the electrodes 711 and 712 made of a graphite intercalation compound. For example, the produced hydroxide ions are supplied to a surface of the workpiece 714. The concentration of the hydroxide ions is thus increased near the workpiece 714, and atoms in the workpiece 714 and the hydroxide ions are reacted with each other to perform removal of a surface layer of the workpiece 714.

Thus, it is possible to reduce the distance between the electrodes 711, 712 and the workpiece (substrate) 714 and hence the distance between the electrode 711 serving as an anode and the electrode 712 serving as a cathode. Therefore, the electrolytic processing apparatus can flexibly cope with small electrodes and various shapes of electrodes. Furthermore, because the electrode 711 serving as an anode and the electrode 712 serving as a cathode have catalysis, a leakage current can be prevented from being produced between the cathode and the anode, i.e., between the electrodes 711 and 712.

Such an electrode, which includes a graphite intercalation compound containing alkali metal, can be used in a substrate processing apparatus or an electrolytic processing apparatus of the above embodiments shown in FIGS. 5 through 11 and FIGS. 13 through 24, instead of an electrode in which an organic compound is chemically bonded to a surface of a conductive material.

Methods of synthesizing a graphite intercalation compound include a gaseous phase constant-pressure reaction method, a liquid phase contact reaction method, a solid phase pressurizing method, and a solvent method. The gaseous phase constant-pressure reaction method comprises disposing alkali metal and graphite at different positions in a glass tube, sealing the glass tube under a vacuum, and heating the graphite and the alkali metal while controlling the temperatures thereof. The positions into which the alkali metal is intercalated and the amount of the alkali metal intercalated can be adjusted by controlling the temperatures of the alkali metal and the graphite. For example, when potassium is intercalated into HOPG, the temperatures are set at about 250° C. The liquid phase contact reaction method comprises directly contacting a compound containing alkali in a liquid phase with graphite to react with each other. The solid phase pressurizing method comprises contacting alkali metal with graphite, pressurizing the graphite to about 5 to about 20 atmospheres (about 0.5 to about 2 MPa), and heating the graphite to about 200° C. The solvent method comprises dissolving alkali metal in a solvent such as an ammonium solvent, and immersing graphite in the solvent.

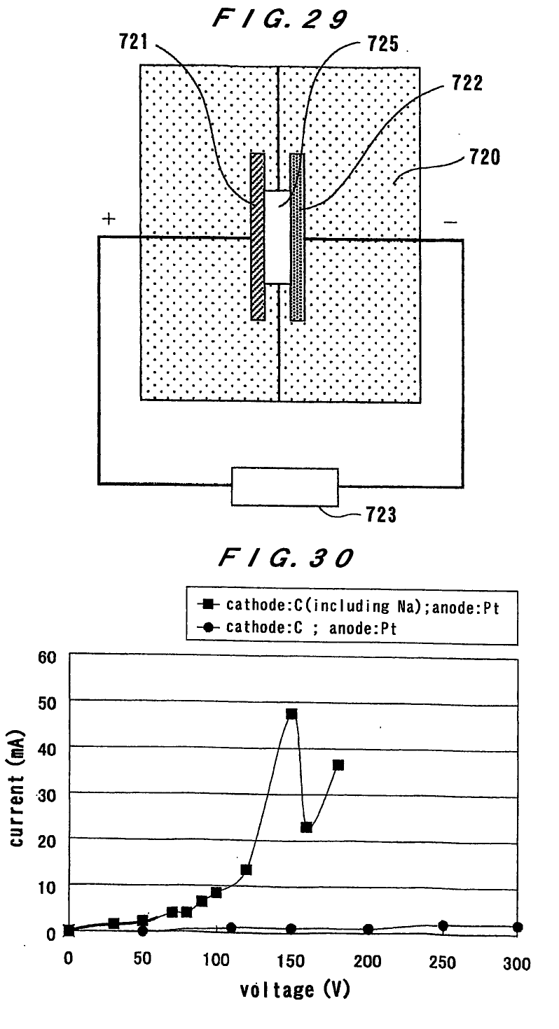

According to the liquid phase contact reaction method, an electrode made of a graphite intercalation compound containing alkali metal was produced (synthesized) as follows. Sodium nitrate, which has a melting point of 308° C., was heated and melted in a crucible by a burner. A graphite plate, which had a length of 12.5 mm, a width of 34 mm, and a thickness of 0.5 mm, was immersed in the melted sodium nitrate and heated therein for 2 to 3 minutes. Then, the graphite plate was removed from the crucible and cooled in air. Thus, an electrode made of a graphite intercalation compound having sodium intercalated between layers of the graphite was produced. Then, the current-voltage properties were measured in an experimental device as shown in FIG. 29. The experimental device had an acrylic container 720, and a pair of parallel plate electrodes 721 and 722. The electrode made of a graphite intercalation compound was used as the electrode 721, and a platinum plate was used as the electrode 722. These electrodes 721 and 722 were connected to an anode and a cathode of a power supply 723, respectively. The current-voltage properties were measured in ultrapure water 725, which had a resistivity of 18.2 MΩ·cm. At that time, the distance between the electrodes 721 and 722 was set to be 12 μm, and areas of the electrodes 721 and 722 facing each other were set to be about 0.4 cm².

Further, the current-voltage properties were measured in a manner similar to the above for a comparative experiment in which a graphite plate in which sodium was not intercalated between layers of the graphite was used as the electrode.

FIG. 30 shows results of the above experiments. It can be seen from FIG. 30 that the electrode made of a graphite intercalation compound having sodium intercalated between layers of the graphite supplied a current slight lower than 50 mA (a current density of 125 mA·m²) at 150 V and thus had increased current by about 50 times as compared to the graphite plate in which sodium was not intercalated between layers of the graphite. Therefore, the graphite intercalation compound having sodium intercalated between layers of the graphite is considered to be capable of promoting the dissociation of ultrapure water into hydrogen ions or hydroxide ions.

In the above example, graphite was immersed in a liquid in which sodium nitrate was heated and melted. However, the graphite may be immersed in any salts containing alkali metal, such as potassium nitrate.

A dilute chemical liquid may be added as an additive to pure water. For example, 2-propanol (IPA) may be added to pure water to adjust the polarity of the pure water.

Although certain preferred embodiments of the present invention have been shown and described in detail, it should be understood that various changes and modifications may be made therein without departing from the scope of the appended claims.

### INDUSTRIAL APPLICABILITY

The present invention is applicable to an electrolytic processing apparatus useful for processing a conductive material formed on a surface of a substrate such as a semiconductor wafer or for removing impurities attached to a surface of a substrate.

1. An electrolytic processing apparatus comprising:
at least one processing electrode;
at least one feeding electrode disposed on the same side as said at least one processing electrode with respect to a workpiece;
a workpiece holder for holding the workpiece and bringing the workpiece into contact with or close to said at least one processing electrode;
a power supply for applying a voltage between said at least one processing electrode and said at least one feeding electrode; and
a fluid supply unit for supplying a fluid between the workpiece and said at least one processing electrode,
wherein at least one of said at least one processing electrode and said at least one feeding electrode comprises:
a conductive material; and
an organic compound having an ion exchange group, said organic compound being chemically bonded to a surface of said conductive material to form an ion exchange material on the surface of said conductive material.

2. The electrolytic processing apparatus according to claim 1, wherein said organic compound comprises an organic compound selected from the group consisting of thiol and disulfide.

3. The electrolytic processing apparatus according to claim 1, wherein said ion exchange group comprises at least one of ion exchange groups selected from the group consisting of a sulfonic acid group, a carboxyl group, a quaternary ammonium group, and an amino group.

4. The electrolytic processing apparatus according to claim 1, wherein said conductive material includes at least one of gold, silver, platinum, copper, gallium arsenide, cadmium sulfide, and indium oxide (III).

5. The electrolytic processing apparatus according to claim 1, wherein said at least one processing electrode and said at least one feeding electrode are disposed in a spaced relationship, and
wherein each of said at least one processing electrode and said at least one feeding electrode comprises:
a conductive material; and
an organic compound having an ion exchange group, said organic compound being chemically bonded to a surface of said conductive material to form an ion exchange material on the surface of said conductive material.

6. An electrolytic processing apparatus comprising:
at least one processing electrode;
at least one feeding electrode disposed on the same side as said at least one processing electrode with respect to a workpiece;
a workpiece holder for holding the workpiece and bringing the workpiece into contact with or close to said at least one processing electrode;
a power supply for applying a voltage between said at least one processing electrode and said at least one feeding electrode; and
a fluid supply unit for supplying a fluid between the workpiece and said at least one processing electrode,
wherein at least one of said at least one processing electrode and said at least one feeding electrode comprises:
a conductive carbon material; and
an ionic dissociation functional group chemically modifying a surface of said conductive carbon material.

7. The electrolytic processing apparatus according to claim 6, wherein said ionic dissociation functional group comprises a carboxyl group.

8. The electrolytic processing apparatus according to claim 6, wherein said ionic dissociation functional group comprises at least one of ion exchange groups selected from the group consisting of a quaternary ammonium group, and a tertiary or lower amino group.

9. The electrolytic processing apparatus according to claim 6, wherein said conductive carbon material comprises a conductive carbon material selected from the group consisting of glassy carbon, fullerene, and carbon nanotubes.

10. An electrolytic processing apparatus comprising:
at least one processing electrode;
at least one feeding electrode disposed on the same side as said at least one processing electrode with respect to a workpiece;
a workpiece holder for holding the workpiece and bringing the workpiece into contact with or close to said at least one processing electrode;
a power supply for applying a voltage between said at least one processing electrode and said at least one feeding electrode; and
a fluid supply unit for supplying a fluid between the workpiece and said at least one processing electrode,
wherein at least one of said at least one processing electrode and said at least one feeding electrode comprises a graphite intercalation compound containing alkali metal.

11. The electrolytic processing apparatus according to claim 1, wherein the fluid comprises one of pure water, ultrapure water, a liquid having an electric conductivity of 500 μS/cm or less, and an electrolytic solution having an electric conductivity of 500 μS/cm or less.

12. The electrolytic processing apparatus according to claim 1, further comprising a driving mechanism operable to move the workpiece and at least one of said at least one processing electrode and said at least one feeding electrode relative to each other to provide a relative movement between the workpiece and said at least one of said at least one processing electrode and said at least one feeding electrode.

13. The electrolytic processing apparatus according to claim 12, wherein the relative movement comprises at least one of a rotational movement, a reciprocating movement, an eccentric rotational movement, and a scroll movement.

14. The electrolytic processing apparatus according to claim 13, wherein the relative movement comprises a movement along a surface of the workpiece.

15. The electrolytic processing apparatus according to claim 1, further comprising an electrode unit having said at least one processing electrode, said at least one feeding electrode, and said fluid supply unit.

16. The electrolytic processing apparatus according to claim 1, wherein said at least one processing electrode comprises a plurality of processing electrodes,
wherein said at least one feeding electrode comprises a plurality of feeding electrodes, and
wherein said plurality of processing electrodes and said plurality of feeding electrodes are alternately disposed on the same side of the workpiece.

17. The electrolytic processing apparatus according to claim 1, wherein one of said at least one processing electrode and said at least one feeding electrode is disposed so as to surround the other of said at least one processing electrode and said at least one feeding electrode.

18. The electrolytic processing apparatus according to claim 1, wherein said at least one feeding electrode comprises a plurality of feeding electrodes provided at a peripheral portion of said at least one processing electrode.

19. The electrolytic processing apparatus according to claim 1, wherein said at least one processing electrode comprises a plurality of processing electrodes disposed in parallel with each other at equal intervals.

20. A substrate processing apparatus, comprising:
a loading and unloading section for loading and unloading a substrate;
said electrolytic processing apparatus according to claim 1;
a cleaning device for cleaning the substrate; and
a transfer device for transferring the substrate between said loading and unloading section, said electrolytic processing apparatus, and said cleaning device.

21. The substrate processing apparatus according to claim 20, further comprising a CMP apparatus for chemical mechanical polishing a surface of the substrate.

22. The electrolytic processing apparatus according to claim 6, wherein the fluid comprises one of pure water, ultrapure water, a liquid having an electric conductivity of 500 μS/cm or less, and an electrolytic solution having an electric conductivity of 500 μS/cm or less.

23. The electrolytic processing apparatus according to claim 10, wherein the fluid comprises one of pure water, ultrapure water, a liquid having an electric conductivity of 500 μS/cm or less, and an electrolytic solution having an electric conductivity of 500 μS/cm or less.

24. The electrolytic processing apparatus according to claim 6, further comprising a driving mechanism operable to move the workpiece and at least one of said at least one processing electrode and said at least one feeding electrode relative to each other to provide a relative movement between the workpiece and said at least one of said at least one processing electrode and said at least one feeding electrode.

25. The electrolytic processing apparatus according to claim 10, further comprising a driving mechanism operable to move the workpiece and at least one of said at least one processing electrode and said at least one feeding electrode relative to each other to provide a relative movement between the workpiece and said at least one of said at least one processing electrode and said at least one feeding electrode.

26. The electrolytic processing apparatus according to claim 24, wherein the relative movement comprises at least one of a rotational movement, a reciprocating movement, an eccentric rotational movement, and a scroll movement.

27. The electrolytic processing apparatus according to claim 25, wherein the relative movement comprises at least one of a rotational movement, a reciprocating movement, an eccentric rotational movement, and a scroll movement.

28. The electrolytic processing apparatus according to claim 26, wherein the relative movement comprises a movement along a surface of the workpiece.

29. The electrolytic processing apparatus according to claim 27, wherein the relative movement comprises a movement along a surface of the workpiece.

30. The electrolytic processing apparatus according to claim 6, further comprising an electrode unit having said at least one processing electrode, said at least one feeding electrode, and said fluid supply unit.

31. The electrolytic processing apparatus according to claim 10, further comprising an electrode unit having said at least one processing electrode, said at least one feeding electrode, and said fluid supply unit.

32. The electrolytic processing apparatus according to claim 6, wherein said at least one processing electrode comprises a plurality of processing electrodes,
wherein said at least one feeding electrode comprises a plurality of feeding electrodes, and
wherein said plurality of processing electrodes and said plurality of feeding electrodes are alternately disposed on the same side of the workpiece.

33. The electrolytic processing apparatus according to claim 10, wherein said at least one processing electrode comprises a plurality of processing electrodes,
wherein said at least one feeding electrode comprises a plurality of feeding electrodes, and
wherein said plurality of processing electrodes and said plurality of feeding electrodes are alternately disposed on the same side of the workpiece.

34. The electrolytic processing apparatus according to claim 6, wherein one of said at least one processing electrode and said at least one feeding electrode is disposed so as to surround the other of said at least one processing electrode and said at least one feeding electrode.

35. The electrolytic processing apparatus according to claim 10, wherein one of said at least one processing electrode and said at least one feeding electrode is disposed so as to surround the other of said at least one processing electrode and said at least one feeding electrode.

36. The electrolytic processing apparatus according to claim 6, wherein said at least one feeding electrode comprises a plurality of feeding electrodes provided at a peripheral portion of said at least one processing electrode.

37. The electrolytic processing apparatus according to claim 10, wherein said at least one feeding electrode comprises a plurality of feeding electrodes provided at a peripheral portion of said at least one processing electrode.

38. The electrolytic processing apparatus according to claim 6, wherein said at least one processing electrode comprises a plurality of processing electrodes disposed in parallel with each other at equal intervals.

39. The electrolytic processing apparatus according to claim 6, wherein said at least one processing electrode comprises a plurality of processing electrodes disposed in parallel with each other at equal intervals.

40. A substrate processing apparatus, comprising:
a loading and unloading section for loading and unloading a substrate;
said electrolytic processing apparatus according to claim 6;
a cleaning device for cleaning the substrate; and
a transfer device for transferring the substrate between said loading and unloading section, said electrolytic processing apparatus, and said cleaning device.

41. A substrate processing apparatus, comprising:
a loading and unloading section for loading and unloading a substrate;
said electrolytic processing apparatus according to claim 10;
a cleaning device for cleaning the substrate; and
a transfer device for transferring the substrate between said loading and unloading section, said electrolytic processing apparatus, and said cleaning device.

42. The substrate processing apparatus according to claim 40, further comprising a CMP apparatus for chemical mechanical polishing a surface of the substrate.

43. The substrate processing apparatus according to claim 41, further comprising a CMP apparatus for chemical mechanical polishing a surface of the substrate.
